(19) United States
(12) Patent Application Publication
(10) Pub. No.: US 2023/0292399 A1
(43) Pub. Date: Sep. 14, 2023

(54) RELEASING USER PLANE RESOURCES OF A DATA CONNECTION

(71) Applicant: Lenovo (Singapore) Pte. Ltd., New Tech Park (SG)

(72) Inventors: Genadi Velev, Darmstadt (DE); Prateek Basu Mallick, Dreieich (DE); Ravi Kuchibhotla, Chicago, IL (US); Hyung-Nam Choi, Ottobrunn (DE)

(21) Appl. No.: 18/017,311

(22) PCT Filed: Jul. 23, 2021
(86) PCT No.: PCT/IB2021/056683

§ 371 Date: Jan. 20, 2023

Related U.S. Application Data
(60) Provisional application No. 63/055,852, filed on Jul. 23, 2020.

(51) Int. Cl. H04W 76/36; H04W 24/08

(52) U.S. Cl. CPC H04W 76/36; H04W 24/08

(57) ABSTRACT

Apparatuses, methods, and systems are disclosed for improved suspension of a data connection. One apparatus in a mobile communication network includes a processor and a network interface that receives a notification message from a RNF (e.g., gNB, eNB), said message comprising an indication of an unavailability of radio resources corresponding to a first data connection that uses a first network slice. The processor determines that UP resources of the first data connection are to be suspended and controls the network interface to send a first request message to the RNF, said message comprising an indication to release UP resources corresponding to the first data connection and further comprising an indication to monitor and report an availability of the unavailable radio resources.

### CROSS-REFERENCE TO RELATED APPLICATIONS

This application claims priority to United States Provisional Patent Application Number 63/055,852 entitled “NON-HOMOGENOUS COVERAGE OF A NETWORK SLICE WITHIN A REGISTRATION AREA” and filed on Jul. 23, 2020 for Genadi Velev, Prateek Basu Mallick, Ravi Kuchibhotla, and Hyung-Nam Choi, which application is incorporated herein by reference.

### FIELD

The subject matter disclosed herein relates generally to wireless communications and more particularly relates to non-homogeneous coverage of a network slice within a registration area.

### BACKGROUND

Certain wireless networks support network slicing. A network slice deployed in a network spans through the radio access network (“RAN”) and core network (“CN”) parts of the network. In a general case, a network slice can be deployed on any cell or frequency band which would fulfil the service requirements for the applications running on the network slice.

### BRIEF SUMMARY

Disclosed are procedures for supporting acknowledgements for downlink (“DL”) data transmitted on uplink (“UL”) resources. Said procedures may be implemented by apparatus, systems, methods, or computer program products.

One method of a Radio Access Network (“RAN”) node includes determining an unavailability of radio resources corresponding to a first data connection that uses a first network slice and sending a notification message to a core network function (“CNF”), said message comprising an indication of the unavailability of the radio resources corresponding to the first data connection. The first method includes receiving a first request message from the CNF, said message comprising an indication to release user plane (“UP”) resources corresponding to the first data connection and further comprising an indication to monitor and report an availability of the unavailable radio resources. The first method includes sending a configuration message to a User Equipment device (“UE”) to release at least one data radio bearer associated with the first data connection and to monitor and report radio resources and/or radio capabilities associated with the first network slice.

One method of a Session Management Function (“SMF”) includes receiving a notification message from a radio network function (“RNF”), said message comprising an indication of an unavailability of radio resources corresponding to a first data connection that uses a first network slice. The method includes determining that UP resources of the first data connection are to be suspended and sending a first request message to the RNF, said message comprising an indication to release UP resources corresponding to the first data connection and further comprising an indication to monitor and report an availability of the unavailable radio resources.

One method of a UE includes receiving from a CNF an indication to suspend UP resources of a first data connection that uses a first network slice and receiving a configuration message from a RNF, said message comprising an indication to release a data radio bearer of the first data connection and an indication to monitor and report radio resources associated with the first network slice. The method includes suspending UP resources of a first data connection and monitoring/reporting the radio resources associated with the first network slice according to the received configuration.

One method of an Access and Mobility Management Function (“AMF”) includes subscribing for unavailability notifications from a network function and receiving a notification message from the network function, said message containing an indication of an unavailability of radio resources corresponding to a first data connection that uses a first network slice. The method includes suspending of UP resources for the network slice in response to the notification message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for non-homogeneous coverage of a network slice within a registration area;

FIG. 2A is a block diagram illustrating one embodiment of a 5G New Radio (“NR”) protocol stack;

FIG. 2B depicts a diagram illustrating one embodiment a deployment scenario of multiple overlapping Frequency Layers and network slices deployed in a particular Frequency Layer;

FIG. 3A depicts a diagram illustrating one embodiment of a procedure to suspend the use of UP resources for a PDU Session (or network slice) due to radio conditions;

FIG. 3B is a continuation of the procedure of FIG. 3A;

FIG. 3C is a continuation of the procedure of FIG. 3B;

FIG. 4A depicts a diagram illustrating one embodiment of a procedure to suspend the UP resource use for a network slice (multiple PDU Sessions) due to radio conditions;

FIG. 4B is a continuation of the procedure of FIG. 4A;

FIG. 5 is a block diagram illustrating one embodiment of a user equipment apparatus that may be used for improved suspension of a data connection;

FIG. 6 is a block diagram illustrating one embodiment of a network equipment apparatus that may be used for improved suspension of a data connection;

FIG. 7 is a block diagram illustrating one embodiment of a first method for improved suspension of a data connection;

FIG. 8 is a block diagram illustrating one embodiment of a second method for improved suspension of a data connection;

FIG. 9 is a block diagram illustrating one embodiment of a third method for improved suspension of a data connection; and

FIG. 10 is a block diagram illustrating one embodiment of a fourth method for improved suspension of a data connection.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for how acknowledgements for non-homogeneous (i.e., “patchy”) coverage of a network slice within a registration area. In some embodiments, a radio network function (“RNF”) determines that the radio resources of the network slice (e.g., S-NSSAI#2) are unavailable and sends a N2 Session Management (“SM”) notification message to the Session Management Function (“SMF”) indicating the unavailability of a network slice due to radio conditions. N2 is the Control Plane (“CP” or “C-plane”) interface between a Radio Access Network (“RAN”) and the 5G Core Network (“5GC”). The RNF receives a message for User Plane (“UP”) resource release, but additionally a) keeping the C-plane PDU Session Context in order to support signaling exchange with the SMF and b) monitoring the radio resources availability for the network slice. Accordingly, the PDU Session is placed in a suspended state where the UP connection is deactivated (corresponding to releasing the UP resource), while the CP connection (corresponding to the CP PDU Session Context) is maintained. When the radio resources of the network slice are available again, the RNF sends a notification to the SMF. In case of a last-active PDU Session, and RRC-Inactive state is configured, the RNF may configure the UE to report radio measurements for FB2.

In some embodiments, a core network function (“CNF”) supports a PDU Session suspended state (e.g., due to unavailability of the radio resources for the network slice) and maintains N2 SM signaling with the RAN for PDU Sessions with deactivated UP connection. The CNF supports N1 SM signaling to suspend a PDU Session in the UE due to unavailability of the network slice due to radio conditions. N1 is the interface between the RAN and the Access and mobility Management Function (“AMF”).

In some embodiments, a UE supports the suspended UP connection sub-state of the PDU Session, supports signaling to/from the core network (e.g., SMF, AMF) to enable or disable the suspension of the UP connection, and supports additional frequency measurement method different from the measurement for neighbor cells.

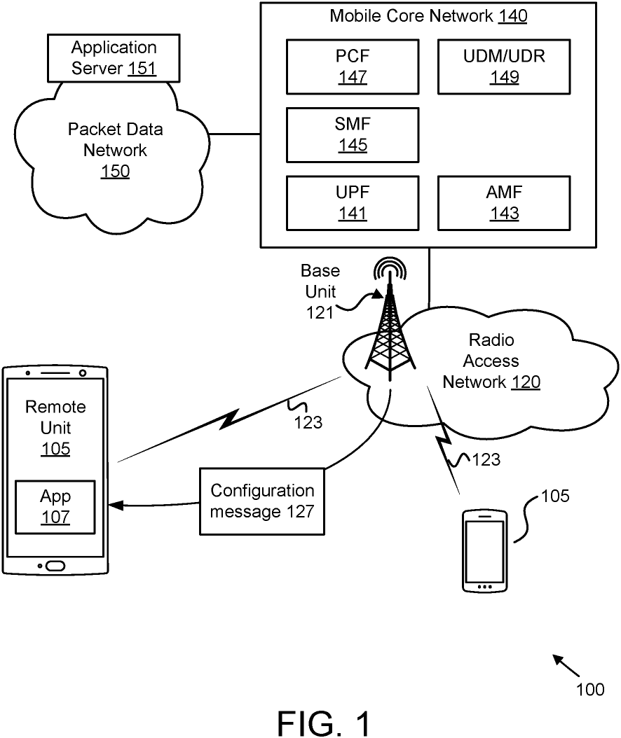

FIG. 1 depicts a wireless communication system 100 for improved suspension of a data connection, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, the base unit(s) 121 may provide a cell operating using a first carrier frequency and/or a cell operating using a second frequency. Cells using the first carrier frequency may form a first frequency layer, while cells using the second carrier frequency may form a second frequency layer.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U″), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. In certain embodiments, there may be an anchor UPF (also referred to as UPF PDU Session Anchor or “UPF PSA”) and at least two intermediate UPFs (“I-UPFs”). The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM″”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination ofNAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for improved suspension of a data connection apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

As described in greater detail below, the base unit 121 may send a configuration message 127 to a remote unit 105 to release at least one data radio bearer associated with a data connection (e.g., PDU session) and to monitor and report radio resources and/or radio capabilities associated with a network slice.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the below described solutions/methods are also equally applicable to other mobile communication systems improved suspension of a data connection.

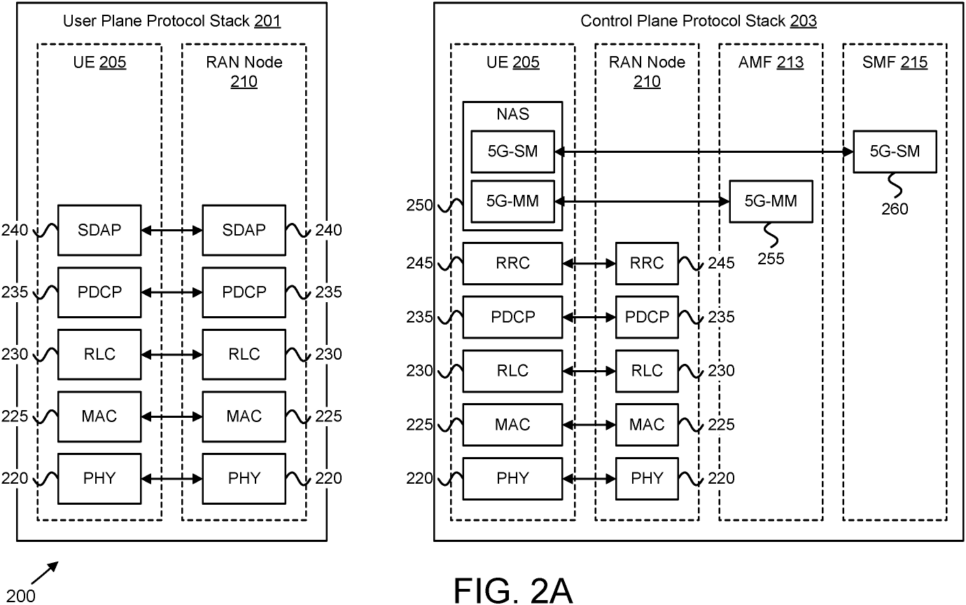

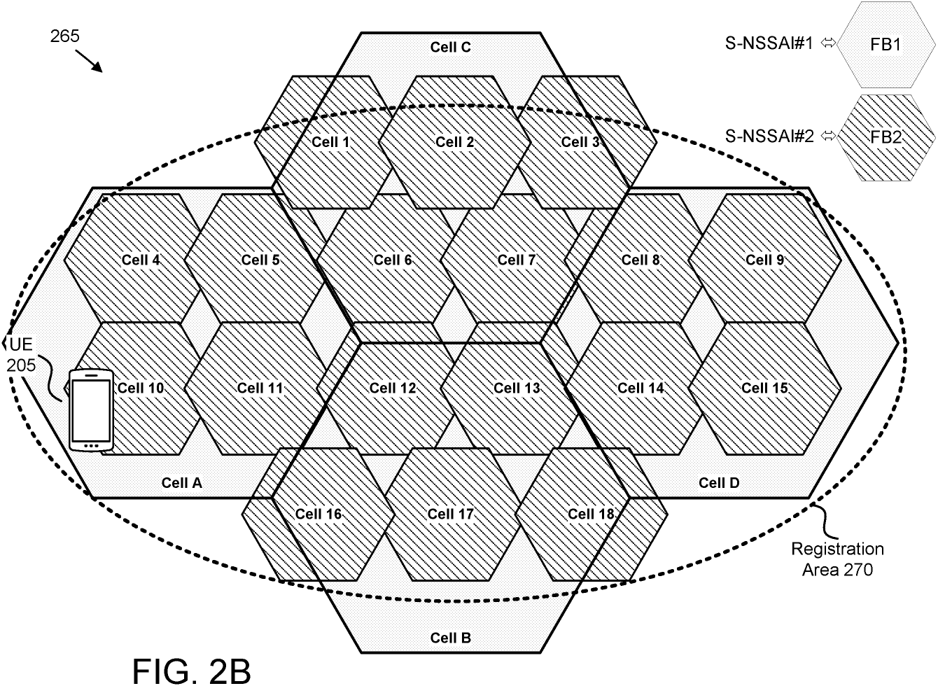

FIG. 2A depicts a NR protocol stack 200, according to embodiments of the disclosure. While FIG. 2A shows the UE 205, the RAN node 210 and an AMF 213 and an SMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

As depicted, the NR NAS layer 250 comprises a 5G NAS Mobility Management (“5G-MM”) sublayer 255 between the UE 205 and the AMF 213 and a 5G NAS Session Management (“5G-SM”) sublayer 260 between the UE 205 and the SMF 215.

FIG. 2B depicts deployment scenario 265 of a RAN portion of mobile communication network with multiple overlapping FBs and network slices deployed in a particular FB, according to embodiments of the disclosure. In the depicted embodiment, the UE 205 is in the coverage area of a first cell (“Cell A”) which operates on a first frequency. Here, the first cell is part of a first frequency layer which supports a first set of network slices. For example, a slice that supports a first service ‘i’ (depicted as “slice-i”) and a slice that supports a second service ‘ii’ (depicted as “slice-ii”) may be part of the first set of network slices. The first cell may be representative of any cell on the first frequency layer.

As shown, the UE 205 is also within the coverage area of a second cell (“Cell 10”) which operates on a second frequency different than the first frequency. Here, the second cell is part of a second frequency layer which supports a second set of network slices, different than the first set. For example, a slice that supports a first service ‘x’ (depicted as “slice-x”) and a slice that supports a second service ‘y’ (depicted as “slice-y”) may be part of the second set of network slices. Here, the second cell may be representative of any cell on the second frequency layer.

The first frequency layer is a collection of cells (or cell sectors) that operate on the same carrier frequency, i.e., the first frequency band ‘FB1’. In the depicted embodiment, the first frequency layer includes the lettered cells, i.e., Cell A, Cell B, Cell C, and Cell D. Here, the first set of network slices may be prioritized for use with frequency band ‘FB1’. Therefore, the UE 205 may be configured to camp on the first frequency layer when within a certain geographic area. In some embodiments, the geographic coverage area of cells in the first frequency layer may be contiguous.

The second frequency layer is a second collection of cells (or cell sectors) that operate on the same carrier frequency, i.e., the second frequency ‘FB2’. In the depicted embodiment, the first frequency layer includes the numbered cells, e.g., Cell 1, Cell 2, Cell 3, ... Cell 10, ... Cell 18. Here, the second set of network slices is prioritized for use with frequency ‘FB2’. In the depicted embodiment, the geographic coverage area of cells of the second frequency layer is not contiguous. However, in other embodiments one or more cells of the second frequency layer may have contiguous coverage areas.

With the evolution of 5G and gathering experience with deployments, especially deployments of non-public networks, it became clear that there is a need to deploy specific network slices in a single or limited set of frequency bands. Such specific frequency bands may be frequency spectrum assigned to private organizations. As a whole, the network may have some network slices operating in any available frequency band, whereas there may be also network slices operating in a single or limited set of frequency bands.

Current 3GPP standards assume that the network slice coverage in the RAN 120 is homogeneous within a topologic area, e.g., a tracking area. This means that a device (e.g., UE 205) would always enjoy the services of the network slice which is included (as S-NSSAI) within the Allowed NSSAI to the UE 205.

However, in cases when a particular network slice is configured to operate in a single frequency band (“FB”) (alternatively, frequency layer) or limited frequency bands/layers, the availability of this network slice (i.e., of the cells operating in the limited FBs) may not always be homogeneous within the topologic area (e.g., registration area 270 for the UE 205).

The cells operating in FB1, e.g., a lower frequency band below 2 GHz, may be available homogeneously in the registration area 270. The cells operating in FB2, e.g., a higher frequency band in 4 GHz, may not be available homogeneously as shown in FIG. 2B. It can be assumed that all cells operating in FB1 and in FB2 are configured with the same tracking area code (“TAC”).

Use case: The S-NSSAI#2 is deployed to operate in FB2 only. The S-NSSAI#2 is part of the Allowed NSSAI for a UE 205 and the UE 205 has established PDU Session(s) for the S-NSSAI#2. The UE radio capabilities or the radio conditions can change dynamically within a Registration Area (“RA”) 270, for example:

Use case A: UE’s Radio Capabilities (“RC”) are reduced (e.g., due to over-heating). Consequently, FB2 cannot be used, which results in situation that the associated network slice S-NSSAI#2 cannot be used temporarily/locally; or

Use case B: Due to mobility the UE 205 moves to an area where particular FB2 associated with a network slice becomes unavailable (out of coverage for the FB2). This is meant for intra-cell mobility (i.e., mobility within the same cell), but it can be also applied to inter-cell mobility (i.e., when UE hands-over between cells).

The conditions from use cases A and B result in inability to use a network slice (S-NSSAI#2) which is deployed in this specific FB (e.g., FB2). This situation occurs when the UE 205 is in Connected state. The RAN node 210 would initiate the release procedure for the Data Radio Bearers (“DRBs”) corresponding to the S-NSSAI#2. This would result in release of the UP resources associated with PDU Session(s) over S-NSSAI#2 in FB2. However, it is not clear what is the state of the S-NSSAI#2′s PDU Session(s). For example, it is unclear whether the SMF 215 should activate the UP resources of the PDU Session(s) if downlink packets for S-NSSAI#2 arrive. Thus, one problem is how to treat the data packets for a PDU Session(s) for which there are currently no available radio resources.

In 4G (e.g., LTE/EPC) it is also possible that a UE 205 using e.g., dual connectivity (“DC”) loses connection in the secondary cell. In such case a procedure is performed to handover the DRB(s) used in the secondary cell to the master/primary cell. However, in case of 5G DC (e.g., multi-radio dual connectivity or “MR-DC”) and in the use case from FIG. 2B where the FB2 is dedicated to a particular network slice, handover of the DRB(s) is not possible because existing DRBs, or in general PDU Sessions, cannot be handed-over or used in another network slice (at least as per 3GPP Release 15 and Release 16 principles). Further, according to the assumption in FIG. 2B, the S-NSSAI#2 is only allowed to operate in FB2, i.e., the PDU Session(s) and corresponding DRBs cannot be relocated in another FB. The applications 107 using the S-NS SAI#2 may start using another network slice, but this is up to the configuration in the UE 205 (e.g., UE Route Selection Policy, URSP, rules). Basically, in such use case the UE 205 is able to use a subset of the allowed network slices, i.e., a subset of the S-NSSAIs of the Allowed NSSAI.

The present disclosure describes solutions for the following issues: how to treat the (uplink and downlink) data packets for a PDU Session(s) for which there are currently no available radio resources. Note that if it is assumed that the data packets transmission should be suspended, then the specific problem raises how to block/suspend and re-enable the data transmission of PDU Session(s) running over network slice with unavailable radio resources/coverage. In other words, a solution is needed how to suspend and re-enable UP connection(s) for a temporarily/locally unavailable network slice.

This solution is exemplary described for the 5G (R)AN, but it can be applied to any type of access network (“AN”) that supports network slicing. In this document the (R)AN (or simpler just “RAN”) term is used to denote that the access technology can be of any type and the RAN node 210 can be gNB, eNB, NG-eNB, N3IWF or any other type of access network node.

The proposed solution is based on the release of the user plane (“UP”) resources for the PDU Session (s) associated with the network slice, for which the radio resources are unavailable, but the N2 SM association between the RAN 120 and the SMF 145 is kept. The term “suspended UP resources” of the PDU Session is used to discriminate from the “release of the UP resources” of the PDU Session, as in case of “suspended UP resources” of the PDU Session the control plane (“CP”) signaling for the PDU Session is still possible and CP context in the RAN 120 is still kept.

In the 3GPP PDU Session establishment procedure, the RAN 120 may reply to the SMF 215. If the N2 SM information indicates failure of user plane resource setup, the SMF 145 rejects the PDU session establishment by including a N1 SM container with a PDU Session Establishment Reject message (see, e.g., clause 8.3.3 of 3GPP TS 24.501) in the Nsmf_PDUSession_UpdateSMContext Response.

If the User Plane Enforcement Policy Notification in the N2 SM information indicates that no user plane resources could be established, and the User Plane Enforcement Policy indicated “required”, e.g., as described in clause 5.10.3 of TS 23.501, the SMF 145 rejects the PDU session establishment by including a N1 SM container with a PDU Session Establishment Reject message (see, e.g., clause 8.3.3 of 3GPP TS 24.501) in the Nsmf_PDUSession_UpdateSMContext Response. Accordingly, a PDU Session establishment fails - or is rejected - if the user plane resources are not available. Here, rejection of a PDU Session means that there is no Session context stored in the UE 205 and in the CN (i.e., SMF 145 and AMF 143).

In the 3GPP PDU Session Modification procedure, during AN initiated modification, the RAN 120 may indicate to the SMF 145 when the AN resources onto which a QoS Flow is mapped are released irrespective of whether notification control is configured. The RAN 120 sends the N2 message (PDU Session ID, N2 SM information) to the AMF 143. The N2 SM information includes the QoS Flow Indicator (“QFI”), User location Information and an indication that the QoS Flow is released. The AMF 143 invokes the service operation Nsmf_PDUSession_UpdateSMContext, i.e., including parameters: SM Context ID, N2 SM information.

Regarding AN initiated notification control, if notification control is configured for a Guaranteed Bit Rate (“GBR”) QoS Flow, the RAN 120 sends a N2 message (PDU Session ID, N2 SM information) to SMF when the RAN 120 decides the QoS targets of the QoS Flow cannot be fulfilled or can be fulfilled again, respectively. The N2 SM information includes the QFI and an indication that the QoS targets for that QoS Flow cannot be fulfilled or can be fulfilled again, respectively. When QoS targets cannot be fulfilled, the N2 SM information indicates a reference to the Alternative QoS Profile matching the values of the QoS parameters that the RAN 120 is currently fulfilling, e.g., as specified in clause 5.7.2.4 of 3GPP TS 23.501.

The AMF 213 invokes the Nsmf PDUSession_UpdateSMContext service operation, i.e., including parameters: SM Context ID, N2 SM information. If the PCF 147 has subscribed to the event, the SMF 215 reports this event to the PCF 147 for each Policy and Charging Control Rule (“PCC Rule”) for which notification control is set. The SMF 215 may reply.

The N2 SM information carries information that the AMF 213 shall provide to the RAN 120. It may include the QoS profiles and the corresponding QFIs to notify the RAN 120 that one or more QoS flows were added, or modified. It may include only QFI(s) to notify the RAN 120 that one or more QoS flows were removed.

The SMF 215 may indicate for each QoS Flow whether redundant transmission shall be performed by a corresponding redundant transmission indicator. If the SMF 215 decides to activate redundant transmission, the SMF 215 includes the allocated additional CN Tunnel Info in the N2 SM information. If the SMF 215 decides to perform redundant transmission for new QoS Flow with two I-UPFs, the SMF 215 includes the allocated CN Tunnel Info of the two I-UPFs in the N2 SM information. If the PDU Session Modification was triggered by (R)AN Release, the N2 SM information carries an acknowledgement of the (R)AN Release. If the PDU Session Modification was requested by the UE 205 for a PDU Session that has no established User Plane resources, the N2 SM information provided to the RAN 120 includes information for establishment of User Plane resources.

With respect to the problem of this document, the disadvantage of the “PDU Session Modification” procedure is that while it can be used to modify the UP resources (the QoS flows belonging to the PDU Session), including the radio resources, it can only be used as long as at least one QoS flow for the PDU Session is active. Thus, if all QoS flows are released, then the whole PDU Session context in the RAN 120 is released, i.e., there is no more N2 SM association between the RAN 120 and the SMF 215.

Regarding CN-initiated deactivation of UP connection for an established PDU Session, the SMF 215 may invoke the Namf_Communication_NIN2MessageTransfer service operation, i.e., including parameters: PDU Session ID, N2 SM Information (N2 Resource Release Request (PDU Session ID)) to release the RAN resources associated with the PDU Session.

After the AMF 213 sends the N2 PDU Session Resource Release Command including N2 SM information (N2 Resource Release Request (PDU Session ID)) received from the SMF 145 via N2 to the RAN 120, the RAN 120 may issue RAN-specific signaling exchange (e.g., RRC Connection Reconfiguration) with the UE 205 to release the RAN resources related to the PDU Session received from the AMF 213. When a User Plane connection for a PDU Session is released, the AS layer in the UE 205 indicates it to the NAS layer 250. However, if the UE 205 is in RRC Inactive state, this step is skipped. When the UE 205 becomes RRC Connected state from RRC Inactive state, the RAN 120 and UE 205 synchronize the released radio resources for the deactivated PDU Session as described in 3GPP TS 36.331 and TS 38.331.

With respect to the problem of this document, the disadvantage of the “CN-initiated selective deactivation of UP connection of an existing PDU Session” procedure is that the PDU Session context in the NG-RAN is released and the NG-RAN is not anymore aware about the PDU Session.

Regarding NG-RAN initiated Connection Suspend procedure for the UP Cellular Internet of Things (“CIoT”) optimization, the UE 205 transits to Idle state in AMF 213 and the AMF 213 requests the SMF 215 to suspend the UP connection for the PDU Session. This procedure may be initiated by the serving RAN node 210 when the UE 205 is in CM-CONNECTED and has at least one PDU session with active user plane connection, and RAN node 210 (e.g., NG-eNB) has received indication from the AMF 213 that User Plane CIoT 5GS Optimization, e.g., as defined in clause 5.31.18 of 3GPP TS 23.501, is supported for the UE 205.

Here, the NG-RAN 120 sends the N2 Suspend Request message to the AMF 213, e.g., as described in 3GPP TS 38.413. The AMF 213 enters CM-IDLE with Suspend indicator. Context information related to the NGAP UE association, UE Context and PDU session context, necessary to resume the connection is stored in the UE 205, the RAN node 210 and in the AMF 215. The RAN node 210 may include the Suspend cause, and the N2 SM information.

The RAN node 210 may include the Information On Recommended Cells And NG-RAN For Paging in the N2 Suspend Request message. If available, the AMF 213 shall store this information to be used when paging the UE 205. The NG-RAN includes Information for Enhanced Coverage, if available, in the N2 Suspend Request message.

If Service Gap Control is being applied to the UE 205 and the Service Gap timer is not already running, the Service Gap timer shall be started in the AMF 213 when entering CM-IDLE, unless the connection was initiated after a paging of an MT event, or after a mobility registration procedure without Follow-on Request indication or after a mobility registration procedure for regulatory prioritized services like Emergency services or exception reporting.

For each of the PDU Sessions in the N2 Suspend Request, the AMF 213 invokes Nsmf_PDUSession_UpdateSMContext Request (PDU Session ID, Cause, Operation type, User Location Information, Age of Location Information, N2 SM Information (Secondary RAT usage data)). The Operation Type is set to “UP Suspend” to indicate suspend of user plane resources for the PDU Session.

At Step 3, SMF 215 to UPF 141:. The SMF 215 initiates an N4 Session Modification procedure indicating the need to release the tunnel info of AN terminating N3 between AN and UPF 141, e.g., by sending a N4 Session Modification Request with parameters: “AN Tunnel Info to be suspended” and “Buffering on/off”. Buffering on/off indicates whether the UPF 141 shall buffer incoming DL PDU or not. The UPF 141 sends N4 Session Modification Response to acknowledge the SMF 215 request. The SMF 215 shall maintain the N3 tunnel info (including both AN Tunnel Info and the CN Tunnel Info). The UPF 141 maintains the CN tunnel info as it may receive uplink packets from the AN.

The SMF 215 sends Nsmf PDUSession_UpdateSMContext response to the AMF 213. After response for each PDU session, the AMF 213 sends N2 Suspend Response to NG-RAN 120 to successfully terminate the Connection Suspend procedure initiated by the NG-RAN 120, see e.g., 3GPP TS 38.413. The NG-RAN 120 sends RRC message to suspend the RRC Connection towards the UE 205 including UE Resume ID, see e.g., 3GPP TS 36.300).

If Service Gap Control is applied for the UE 205 (see e.g., 3GPP TS 23.501 clause 5.31.16) and the Service Gap timer is not already running, the Service Gap timer shall be started in the UE 205 when entering CM-IDLE, unless the connection was initiated as a response to paging of an MT event, or after a mobility registration procedure without Follow-on Request Indication set or after a mobility registration procedure for regulatory prioritized services like Emergency services or exception reporting.

Regarding intra-CN Connection Suspend procedure, the NF Service Consumer (e.g., AMF 213) requests the SMF 215 to suspend the User Plane connection of an existing PDU session. The AMF 213 requests the SMF 213 to suspend the user plane connection of the PDU session by sending a POST request with the following information:
upCnxState attribute set to SUSPENDED;
user location and user location timestamp;
other information, if necessary.

Upon receipt of such a request, the SMF 213 deactivates the N3 tunnel of the PDU session, set the upCnxState attribute to SUSPENDED and return a 200 OK response including the upCnxState attribute set to SUSPENDED.

Regarding intra-CN Connection Resume procedure in CM-IDLE with Suspend, the NF Service Consumer (e.g., AMF 213) requests the SMF 215 to resume the User Plane connection of an existing PDU session, i.e., establish the N3 tunnel between the 5G-AN 120 and UPF 141. The AMF 213 requests the SMF 215 to resume the user plane connection of the PDU session by sending a POST request with the following information:
the upCnxState attribute set to ACTIVATING;
user location and user location timestamp;
cause attribute set to “PDU_SESSION_RESUMED”;
N2 SM information received from the 5G-AN 120, including the new transport layer address and tunnel endpoint of the downlink termination point for the user data for this PDU session (i.e., 5G-AN’s GTP-U F-TEID for downlink traffic);
additional N2 SM information received from the 5G-AN 120, if any;
the “MO Exception Data Counter” if the UE 205 has accessed the network by using “MO exception data” RRC establishment cause;
other information, if necessary.

If the SMF 215 can proceed with resuming the user plane connection of the PDU session, the SMF 215 shall return a 200 OK response including the following information:
the upCnxState attribute set to ACTIVATED;
N2 SM information, including the transport layer address and tunnel endpoint of the uplink termination point for the user data for this PDU session (i.e., UPF’s GTP-U F-TEID for uplink traffic).

If the “MO Exception Data Counter” is included in the request and Small Data Rate Control is enabled for the PDU session, the V-SMF shall update the H-SMF (see clause 5.2.2.8.2.2) for HR PDU Session (or I-SMF shall update the SMF for PDU session with I-SMF).

If the SMF 215 cannot proceed with resuming the user plane connection of the PDU session, the SMF 215 shall return an error response, including:
the upCnxState attribute representing the final state of the user plane connection (e.g., SUSPENDED);
N2 SM information, including the cause of the failure.

Please note the that the “Connection Suspend procedure” results from the mapping of the 4G CIoT feature of “User Plane CIoT 5GS Optimization” where the NB-IoT RAN node is connected to the 5GC. The state “CM-IDLE with Suspend indicator” in the AMF is copied from a similar state in the 4G MME. The reason to apply the Connection Suspend procedure is due to inactivity (i.e., no UL/DL data transmission for a specific time) on the DRB. Then the RAN node decides to trigger the Connection Suspend procedure. This is different from the problem considered herein, where the radio resources to for the data transmission (for a specific network slice) are not available.

As discussed above, the existing solutions do not solve the problem of this disclosure, as none of the existing mechanisms, (i.e.: “Release of the UP resources” causes removal of the PDU Session context in the (R)AN 120 and the N2 SM association between the (R)AN 120 and the SMF 215 is deleted or the “Connection Suspend procedure” due to inactivity over the DRBs) allows to solve the problem of how to suspend and re-enable UP connection(s) for a temporarily/locally unavailable radio resources for a network slice.

According to a first solution, when the RAN 120 determines that a particular network slices (e.g., S-NSSAI#2) is not available (e.g., due to poor radio coverage in the FB2 or reduced radio capability), the RAN node 210 sends a notification message to the core network (e.g., SMF 215) to indicate the unavailability of the network slice (e.g., S-NSSAI#2) and the reason for unavailability. Based on the reason for unavailability, the SMF 215 determines to release the UP resources and to suspend the UP resources of the PDU Session(s) associated with the unavailable network slice. The SMF 215 initiates procedure for UP resource release towards the RAN node 210 with a new indication to keep (at least part of) the CP PDU Session context in the RAN 120 in order to monitor the radio resource availability and notify the SMF 215 about available resources. Correspondingly, the SMF 215 requests the UE 205 to release (i.e., suspend) the UP resources of the PDU Session(s) with a new release cause indicating the radio resource unavailability.

Currently, the 5G Session Management (“5G-SM”) sub-layer 255 of NAS defines the PDU Session states in the UE 205 and in the network (i.e., SMF 215) are Inactive (i.e., no PDU session exists) and Active (i.e., PDU session is active and valid PDU Session context is stored). There are also the Pending states which are used during the time of SM signaling exchange. It is proposed that a new sub-state (or state) for a PDU Session is introduced - Suspended state for UP resources, which may be a sub-state of the Active PDU Session state. The suspended state for UP resources of PDU Session means that the session management (SM) context (e.g., including QoS rules, traffic filters, etc.) is kept in the UE 205 and SMF 215 and RAN 210 (e.g., only a part of SM context in the RAN 120 for CP signaling exchange can be kept), but the UP data transfer is blocked/suspended until the radio conditions for the network slice improve. The PDU Session Suspended state is determined in the SMF 215 and signaled to the UE 205 via e.g., N1 SM PDU Session Modification procedure. Please note that the CP signaling for the PDU Session is still possible, e.g., since the UE 205 is still in coverage and reachable via the NAS signaling, merely the UP resources of the PDU Session(s) associated with the S-NSSAI#2 are suspended.

Please note that in case of Session Management (“SM”) back-off timer sent from the CN to the UE 205, the UE 205 stops the NAS SM signaling to the network, i.e., the C-plane signaling is blocked/suspended. The difference to the solution of Suspended PDU Session state is that in Suspended PDU Session state the UP data exchange for the PDU Session is blocked/suspended, whereas the C-plane signaling can continue to be exchanged. It is to be noted that UP resources (or also called UP connection) are the resources between the UE 205 and the UPF 141. The UP resources consist of one of the: UP radio bearers via the Uu reference point, a tunnel via the N3 reference point and a tunnel via the N9 reference point (if any) for 3GPP access. N3 in the interface between the RAN and the initial UPF. N9 is the inter-UPF interface, i.e., between an I-UPF and the UPF PSA.

The high-level principle of the solution can be also described in a way that the S-NSSAI, which is associated with the specific unavailable FB, is suspended. The same behavior in the UE 205 and in the network would be applicable independent whether all PDU Sessions via S-NSSAI#2 are suspended, or the S-NSSAI#2 is suspended. With other words, it is interchangeable whether network slice is suspended or all PDU Sessions for a network slice is suspended.

Once the SMF 215 has activated the suspension of UP resource for a PDU Session and has subscribed with the RAN node 210 to report the availability of radio resources of S-NSSAI#2, based on network configuration (i.e., smart network using Machine Learning (“ML”) and/or Artificial Intelligence (“AI”)) the SMF 215 may deactivate the PDU Session Suspended state and change to normal Active state of the PDU Session with released UP resources. For this purpose, the SMF 215 may request:
the RAN node 210 to release/delete the complete PDU Session context, i.e., to stop monitoring the availability of the radio resources for S-NSSAI#2; and
the UE via N1 SM signaling to deactivate the Suspended state of the PDU Session and to transit to PDU Session Active state.

Please note that in the solution description the term unavailable radio resource (“RR”) is used as high-level term to express that the UE 205 is 1) out of coverage for a radio frequency band(s), or radio carrier frequencies where a network slice is operating, or 2) the signal-to-noise ratio for a specific frequency or frequency band is below a configured threshold.

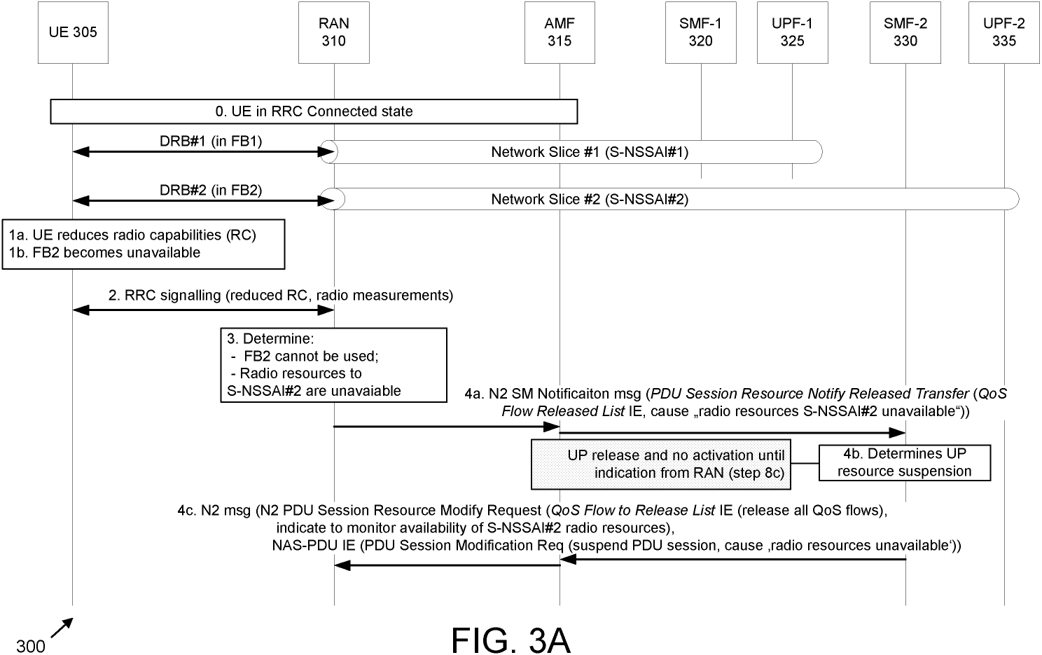

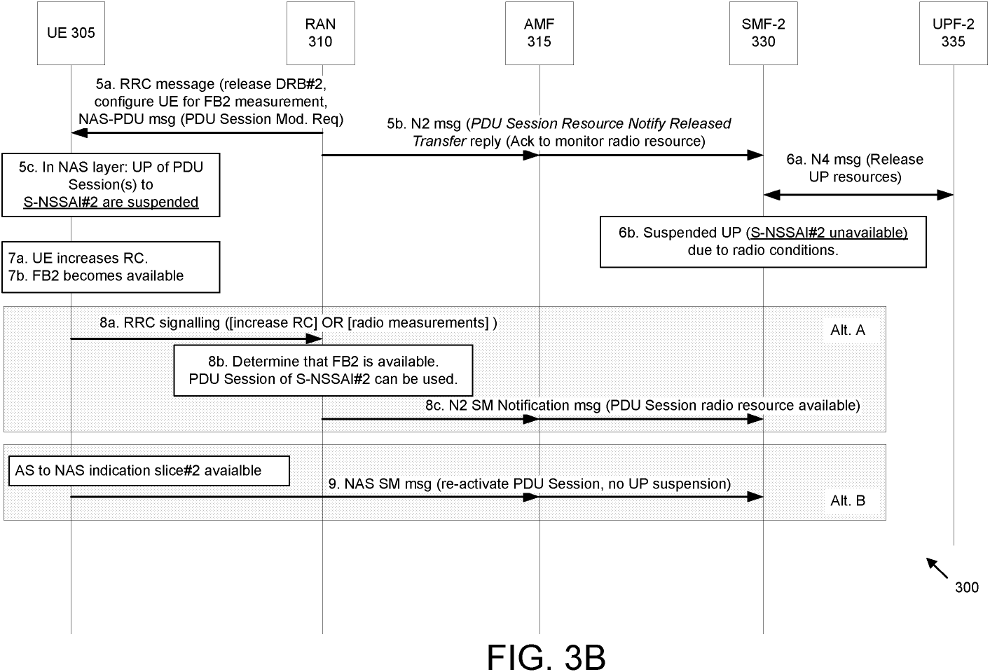

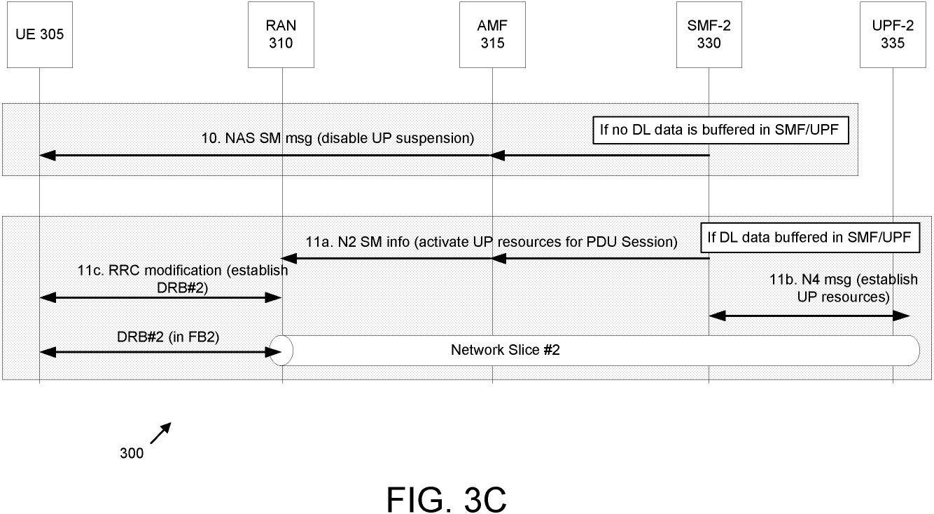

FIGS. 3A-3C depict a procedure 300 for suspending the use of UP resources for a PDU Session (or network slice) due to radio conditions. The procedure 300 involves a UE 305, a RAN 310, an AMF 315, a first SMF (“SMF-1”) 320, a first UPF (“UPF-1”) 325, a second SMF (“SMF-2”) 330, and a second UPF (“UPF-2”) 335. Here, the UE 305 is one embodiment of the UE 250 and remote unit 105, the RAN 310 is one embodiment of the RAN 120 (e.g., containing a RAN node 210), the SMF-1 320 and SMF-2 330 are embodiments of the SMF 145 and SMF 215, the UPF-1 325 and UPF-2 325 are embodiments of the UPF 141. The procedure 300 shows the detailed call flow for a UE in Connected state (CM-Connected and RRC-Connected) when the proposed solution of suspended UP resources for S-NSSA#2 is applied.

Connection Management (“CM”) is used to establish and release the control plane signaling connection between the UE 305 and the AMF 315. Connection Management indicates the UE 305 status with respect to its signaling with the AMF 315. The Signaling Connection between UE and AMF is based on N1 logical interface and it is combination of following: RRC signaling between the UE 305 and the RAN 310 (i.e., gNB), and N2-AP signaling between the RAN 310 (i.e., gNB) and the AMF 315. Currently, two CM States are defined with respect to the UE 305 and the AMF 315: the CM-Idle state and the CM-Connected.

The CM-Idle state refers to the situation where the UE 305 does not have a signaling connection with the AMF 315. Here, the UE 305 is also in RRC Idle state. As an example, the UE 305 may be in CM-Idle state and moving across different cells controlled by mobility based on cell reselection. The CM-Connected state refers to the situation where the UE 305 has a signaling connection with the AMF 315. Here, the UE 305 may be in either RRC Connected state or RRC Inactive state. The CM-Idle and CM-Connected states are maintained at NAS layer 250 at both UE 305 and AMF 315.

Beginning on FIG. 3A, at Step 0 the UE 305 has been registered with two network slices identified by S-NSSAI#1 and S-NSSAI#2. It is assumed that in the radio access network the network slice S-NSSAI#1 is operated in one frequency band (e.g., denoted by FB1) and S-NSSAI#1 is operated in another frequency band (e.g., denoted by FB2).

The UE 305 is in Connected mode and user plane (“UP”) connections are activated for both slices S-NSSAI#1 and S-NSSAI#2. The RAN 310 has configured either carrier aggregation (“CA”) or dual connectivity (“DC”) to enable the usage of both network slices simultaneously. Data Radio Bearers (“DRBs”) are established in FB1 for the S-NSSAI#1 and in FB2 for S-NSSAI#2.

At Step 1, due to some conditions the UE 305 is unable to continue to use at least one of the FB currently used. For example, the conditions may be one of step 1a or step 1b.

In step 1a, due to overheating or other UE internal conditions, the UE 305 may determine to reduce the radio capabilities. This may result in reducing the available frequency band usage, especially in higher frequencies, or reducing the frequency band combination.

In step 1b, the UE 305 may experience poor radio coverage for at least one of the used frequency bands. Such scenario might mainly occur in case of intra-cell mobility when the signal strength may vary (especially of higher frequencies), and the UE 305 may experience intervals of time without frequency coverage.

At Step 2, the UE 305 sends RRC signaling to the network to inform either (1) that the UE radio capabilities have been reduced, or (2) within the radio measurements reporting that some frequency bands are received with signal strength below a threshold.

At Step 3, the RAN 310 determines that specific radio resources currently used for some of the DRBs (e.g., FB2) are not available. The unavailability can be either (1) due to the reduced UE radio capability or (2) due to the UE 305 being out of coverage for a FB. As there are existing DRBs setup on the unavailable FB, and the limitation that the DRB(s) cannot be handed over to another cell/FB, the RAN 310 determines to release the DRB(s) and to inform the CN (e.g., SMF-2 330) about the UP resource release and the reason for release, e.g., due to unavailable radio resources for the PDU Session/network slice.

The radio conditions for the FB2 may improve in short time, e.g., a couple of seconds, or the radio conditions for FB2 may be worse for longer time, e.g., minutes or hours. In case of reduced radio capability, the FB2 may become available in short time. In case of lost coverage for FB2, the recovery of the radio conditions would depend on the UE mobility pattern. If the RAN node 210 may determine recovery level (i.e., the probability of quick recovery), the RAN node 210 may indicate it to the SMF-1 320.

Please note that the frequency FB2 coverage may become poor for the UE 305 due to mobility within the same cell (i.e., intra-cell mobility), but it is also possible that the UE 305 hands over between cells (i.e., inter-cell mobility).

At Step 4a, the RAN node 210 sends N2 SM Notification message to the AMF 315 to further indicate the SMF-2 330 that the already established QoS flow(s) or PDU session(s) are to be released. For example, the RAN node 210 uses PDU Session Management messages and may send PDU Session Resource Notify message or PDU Session Resource Modify Indication message. This message can contain for one or more PDU Session(s) the informational element PDU Session Resource Notify Released Transfer IE (QoS Flow Released List IE, cause “radio resources S-NSSAI#2 unavailable”) which the AMF 315 forwards to each SMF serving the indicated PDU Sessions. Table 1 gives example cause values which can be used:

TABLE 1

| | |
|---|---|
| Radio Network Layer cause | Meaning |
| Release due to NG-RAN generated reason | Release is initiated due to NG-RAN generated reason. |
| Radio resources not available | No requested radio resources are available. |
| Failure in the radio interface procedure | Radio interface procedure has failed. |
| Resources not available for the slice(s) | The requested resources are not available for the slice(s). |

Alternatively, a new indication can be introduced to inform the SMF-2 330 that the radio resources for the network slice (e.g., S-NSSAI#2) are not available currently for any QoS level but may become available soon, i.e., temporary/locally unavailable radio resources. For example, such new indication can be called “resources temporary/locally not available for the network slice” or “frequency band not available for the network slice”.

The AMF 315 may use Namf_Communication_N1N2MessageTransfer or Nsmf_PDUSession_UpdateSMContext Request service operation to transmit the N2 SM message. The message from AMF 315 may contain at least one of the following: PDU Session ID, Cause, User Location Information, Age of Location Information, N2 SM Information (indication for radio resource unavailability for the PDU Session or network slice).

At Step 4b, based on the received indication from the RAN 310 about the unavailable radio resources, the SMF-2 330 determines that the UP resources should be released and the UP resources of the PDU Session may be suspended, i.e., no UP resource activation is triggered until further indication from the RAN 310 that the radio resources are available again. The SMF-2 330 does not try to use alternative QoS profiles for the PDU Session, as the SMF-2 330 knows that any QoS profile would be rejected by the RAN 310.

At Step 4c, the SMF-2 330 sends to the RAN 310 a N2 SM message to indicate that the UP resources of one or more PDU Session(s) are to be released. For example, the SMF-2 330 may send PDU Session Resource Modify Request or PDU Session Resource Release Command. This N2 message may contain QoS Flow to Release List IE (release all QoS flows) and additional indication to the RAN 310 to a) keep N2 SM association with the SMF-2 330, i.e., use Notification procedure; and b) to monitor availability of S-NSSAI#2 radio resources.

In addition, the SMF-2 330 may send to the UE 305 transparently through the AMF 315 and RAN 310 a N1 SM PDU Session Modification Command message to inform the UE 305 to suspend the PDU session, i.e., to release UP resources of the PDU Session and to block UP resource activation until further notification from the SMF-2 330 arrives. The SMF-2 330 may include a new cause value e.g., “radio resources unavailable”.

If this is the last active PDU session and all QoS flows are released, the RAN 310 may determine to keep the UE 305 in CM-Connected state and determine the RRC state to be either RRC-Connected or RRC-Inactive. If it is in RRC-Inactive state, the RAN 310 may configure the UE 305 to measure FB2 and report radio measurements for FB2.

Continuing on FIG. 3B, at Step 5a, the RAN 310 determines that the UP resources for the included PDU Session(s) are to be released and the RAN 310 initiates RRC signaling towards the UE 305. For example, the RAN 310 performs RRC Connection Reconfiguration procedure to release the DRBs associated with the PDU Session(s). In the particular example of FIG. 3B, the RAN 310 initiates release of DRB#2.

Further, based on the indication from the SMF-2 330 to monitor the radio resources associated with the PDU Session(s), the RAN 310 determines to configure the UE 305 to measure the frequency band and report to the RAN 310 within the radio measurements (e.g., FB2 radio measurement). The RAN 310 may configure a different strategy/mode of radio measurements in the UE 305 for FB2 (as an example). In one example, FB2 is configured as a special measurement object to which the normal performance requirements do not apply. A UE 305 may measure the special measurement object with more often or less often compared with the measurements for other/ legacy/ current-art measurement objects. In one useful implementation, the special measurement object in this case would mean that the said frequency (FB2) is measured less often, thereby saving some battery consumption; network configures a special measurement object when it knows that the frequency to be measured is not available in the vicinity of the UE’s current location (i.e., the serving cell).

In another implementation, there is no special measurement object indicated by the network, but the UE 305 will optimize its battery consumption by iteratively decreasing the frequency of measurements (e.g., from once in a DRX Cycle to once every two DRX Cycles to once every 5 DRX Cycles and so on) if the said frequency measurements remains below a certain threshold. When the measurement of the frequency (e.g., RSRP value) appears above the said threshold, the UE 305 may start to apply the normal measurements to fulfil the measurement performance requirement applicable for any inter-frequency measurements. In another example, the UE 305 may measure the ‘unavailable frequency bands’ only upon change of the location (i.e., detection of mobility).

The RAN 310 node sends also the N1 message if included in the NAS-PDU IE sent from the SMF-2 330. For example, the NAS SM PDU Session Modification Request message (suspend PDU session, cause “radio resources unavailable”).

At Step 5b, the RAN 310 sends to SMF-2 330 a N2 SM message to indicate that the RAN 310 has accepted the request for UP resource suspension of the PDU Session. For example, the RAN 310 can send a PDU Session Resource Notify Released Transfer reply including an indication that the monitoring of radio resources for S-NSSAI#2 is acknowledged.

If the RAN 310 replies negatively to the SMF-2 330, i.e., due to the RAN 310 not supporting the feature of this solution or cannot configure the UE 305 to monitor the FB2 availability, the SMF-2 330 may decide to keep the PDU Session (with UP connection deactivated) or release the PDU Session. The SMF-2 330 should not apply the new proposed solution of suspended UP resources for the PDU Session. If the SMF-2 330 deactivates the UP resources, the SMF-2 330 may additionally block the DL data transmission for a network configured time. The SMF-2 330 may send a NAS SM message (e.g., PDU Session Modification request) to the UE 305 to indicate that the UL data is to be blocked for some time and indicate the time duration.

At Step 5c, upon reception of the request from the SMF-2 330 to suspend the UP resources for the PDU Session in the NAS SM layer (e.g., 5GSM sublayer) of the UE 305, the UE 305 suspends the UP resource of the PDU Session and may suspend accordingly the UP resources of other PDU Sessions to the same network slice (i.e., S-NSSAI#2). The UE 305 waits for further indication from the SMF-2 330 to resume the UP resources for the PDU Session or network slice.

The UE 305 may reassess the URSP rules to determine whether the traffic of the higher layers (application) can be transmitted over another existing or new PDU Session over allowed and available network slice (e.g., S-NSSAI#1). If this is possible, the UE 305 re-routes the data over the existing PDU Session or establishes a new PDU Session via S-NSSAI#1. If it is not possible, the UE 305 indicates to the application layer that the connectivity for this application is not available.

If the data/traffic of the application(s) associated with the PDU Sessions with suspended UP resources cannot be re-routed over another PDU Session(s) belonging to another network slice, the UE 305 may send a notification to the application layer or to the graphical user interface (“GUI”) to indicate about the reason for the unavailable connection for the particular application(s). The reason being unavailable radio resources for the data connection (e.g., PDU Session or network slice).

At Step 6a, the SMF-2 330 performs a N4 interface procedure to release the UP resources in the UPF-2 335. The SMF-2 330 may initiate N4 Session Modification Request (AN Tunnel Info to be suspended, Buffering on/off). The SMF-2 330 may indicate the release the tunnel info of AN terminating N3 between the RAN 310 and the UPF-2 335 and whether buffering (e.g., on/off) in the UPF-2 335 shall be activated for incoming DL PDU. Alternatively, the SMF-2 330 may instruct the UPF-2 335 to forward DL packets to the SMF-2 330 (so that the SMF-2 330 may process the packet(s) and decide about the further actions).

At Step 6b, the SMF-2 330 stores locally the state for the PDU Session as suspended due to radio resource unavailability. If the SMF-2 330 maintains multiple PDU Sessions to the same UE 305 associated with the S-NSSAI#2, the SMF-2 330 sets all PDU Sessions associated with the S-NSSAI#2 to suspended state. If the PDU Session is in suspended state, the SMF-2 330 does not initiate activation of the UP resources, i.e., does not send N2 request message to the RAN 310 to establish QoS flows.

In certain embodiments, the UE 305 may transition to an Idle state while the PDU Session #2 is in a “suspended” state. The SMF-2 330 may subscribe with the AMF 315 for notification about the connection management (“CM”) state of the UE 305. When the UE 305 transfers to Idle state, the AMF 315 notifies the SMF-2 330. If the AMF 315 indicates to the SMF-2 330 that the UE 305 has transitioned to Idle state, the SMF-2 330 determines that the RAN 310 has deleted the PDU Session context, and the RAN 310 cannot inform the SMF-2 330 whether the radio resources for S-NSSAI#2 are again available or not. Therefore, the SMF-2 330 disables the suspended state (of the UP resources) of the PDU Session and set the state to normally operated Active state.

Please note the Active state of the PDU Session means that the UP is available for activation, but does not necessary mean that the UP is activated.

At Step 7, the UE 305 determines one of the following:

In step 7a, the UE 305 may determine that the overheating (or other UE internal conditions) is resolved, and the UE 305 may increase the radio capability.

In step 7b, the UE 305 may have measured signal of the FB2 frequencies above a configured threshold for some time. Thus, the UE 305 may determine that the requested FB2 frequencies are available again.

At Step 8a, the UE 305 initiates RRC signaling to indicate to the RAN 310 the event detected in step 7, e.g., either increase of radio capability, or radio measurements reports.

At Step 8b, based on the signaling from the UE 305, the RAN 310 determines that FB2 is available again for this UE 305. The RAN 310 decides to notify the SMF-2 330, as per configuration in step 4c. The RAN 310 may setup different levels for the signal strength threshold depending on the particular QoS requirements for this PDU Session or network slice. For example, for some slices lower threshold can be configured, whereas for other slices higher threshold may be configured.

At Step 8c, the RAN 310 notifies the SMF-2 330 that the radio resources are available for PDU Session of S-NSSAI#2. For example, the RAN 310 can send N2 SM Notification message (PDU Session radio resources available) to the SMF-2 330 including a new indication that the radio resources for the network slice (i.e., S-NSSAI#2) are available again. The SMF-2 330 disables the suspended state (of the UP resources) of the PDU Session and set the state to normally operated Active state.

If (buffered) DL data for the PDU Session is to be transmitted, the SMF-2 330 initiates N4 procedure to the UPF-2 335 to activate the UP resources for the PDU Session.

At Step 9, this step shown an alternative (Alt. B) to step 8. The monitoring of the radio conditions is performed by the access stratum (“AS”) layer in the UE 305. When the AS detects that the conditions in step 7 occur, the AS notifies the NAS layer that the radio resources for S-NSSAI#2 available again. The NAS layer can send a N1 NAS SM message (e.g., PDU Session Modification request) for all PDU Sessions which have been established to S-NSSAI#2, whereas the message includes an indication that the radio resources are available again, i.e., the suspended state of the UP resources can be reset.

Continuing on FIG. 3C, at Step 10 if there are (valid) buffered DL packets for transmission, the SMF-2 330 sends NAS SM signaling (e.g., PDU Session Modification request) to the UE 305 to indicate that the suspended UP resources are enabled. This would allow the UE 305 to send UL data over this PDU Session.

At Step 11, if there are (valid) buffered DL packets for transmission, the SMF-2 330 initiates the activation of the UP resources for the PDU Session towards the UPF-2 335 and towards the RAN 310.

After the DRBs are established, the AS layer in the UE 305 notifies the NAS layer about the successfully established DRBs for the PDU Session. Based on this indication, the UE 305 updates the state of the PDU Session and disables the Suspended state for UP resources, i.e., the UE 305 can at any time request activation of the UP resources. Alternatively, the SMF-2 330 may send an explicit NAS SM signaling to the UE 305 to indicate the enablement of the suspended UP resources.

For both steps 10 and 11, the UE 305 can further perform one of the following depending on the conditions in step 5c:

If the UE 305 has re-routed the traffic over existing PDU Session or established a new PDU Session over allowed and available network slice (e.g., S-NSSAI#1), the UE 305 may re-route back the traffic over the activated PDU Session for S-NSSAI#2.

If the UE 305 has previously indicated to higher layers (e.g., applications) that connectivity is not available, the UE 305 indicates that the connectivity is available again.

Please note that the Notification control procedure from RAN 310 to CN (e.g., SMF-2 330) is used today primarily for QoS Parameter Notification control for GBR QoS flows (including the critical PDB QoS flows). This disclosure proposes to enhance the Notification control procedure between the RAN and SMF to allow the monitoring of the radio resources for a PDU Session associated with a network slice and to report to the SMF if the resources are available again.

In the use case of transition from CM-Connected to CM-Idle state during the PDU Session is suspended in the SMF-2 330 and UE 305, the problem occurs that the RAN 310 cannot report the available radio resources to the SMF-2 330. The proposed solution is similar to what is described in step 6b in FIG. 3B, i.e., the SMF-2 330 is notified from the AMF 315when the UE 305 transits to Idle state. The SMF-2 330 may subscribe with the AMF 315 for notification for the event of transition from Connected to Idle state. Based on this notification, the SMF-2 330 determines to disable the suspended state of the UP resources, i.e., SMF-2 330 enables the activation of UP resources for data transmission, which in this particular case means enabling the paging of the UE 305 for DL data.

In one embodiment, if in FIG. 3A step 3 the RAN 310 determines that handover to a target cell is required and the target cell does not support the FB2, the solution applies as well with the changes resulting from the type of handover procedure (i.e., Xn based or inter NG-RAN node N2 based handover). Please note that the FB2 may not be available only in the cell edge (of the target cell) or in the whole target cell. Here:
a. If Xn based handover is performed (e.g., inter-RAN node), either the source RAN node or the target RAN node indicates to the SMF that DRB2 is to be released and the cause value as per step 4a. The RAN node sends an indication to the SMF that the radio resources for the network slice (e.g., FB2 for S-NSSAI#2) are not available currently for any QoS level.
b. If N2 based handover is performed, during the handover preparation phase the source RAN node sends to the AMF a Handover required message. The AMF (source AMF or target AMF) requests the target RAN node to perform the preparation for the handover. If the target RAN node determines that FB2 is not supported, the target RAN node may create a List of PDU Sessions failed to be setup and reason for failure (e.g., T-RAN decision, S-NSSAI is not available, unable to fulfill User Plane Security Enforcement). A new cause/failure value can be introduced, e.g., the radio resources for the network slice (e.g., FB2 for S-NSSAI#2) are not available currently for any QoS level. The AMF may send to the SMF Nsmf_PDUSession_UpdateSMContext Request (PDU Session ID, N2 SM response received from T-RAN).

For any of the cases a) and b), if the SMF-2 330 determines as described in step 4b that the UP resources for the PDU Sessions are to be released and suspended, the SMF-2 330 may perform the steps as shown in FIGS. 3A-3C to release the UP resources of the PDU Sessions and to suspend the UP resources.

According to a second solution (e.g., AMF-based solution), it is assumed that the AMF may take over the control of the availability of resources for a network slice. In the embodiment described in FIGS. 3A-3C, the resource availability is controlled per PDU Session. Usually, the state or conditions of one PDU Session does not influence the state/conditions for another PDU Session. Especially in case where multiple PDU Sessions are set up for a network slice and different SMFs are used to control the multiple PDU Sessions, there may be a need to control all PDU Sessions of a network slice in a centralized manner. The second solution assumes that the AMF takes upon such centralized control.

High-level principles of the second solution are shown as follows:
The AMF is aware about that the network slices allowed for a UE are operating in different frequency bands. The AMF subscribes with the RAN or SMF to be informed if the radio resources (“RR”) for a particular slice (e.g., S-NSSAI#2) are not available.
The AMF is indicated that the radio resources for a network slice are not available
   RAN may indicate the unavailable radio resources for the network slice to the AMF via a N2 Notification message.
   SMF may indicate the unavailable radio resources for the network slice to the AMF.
The AMF may take one of the following actions:
   A. Sends an indication to the other SMF(s) serving the PDU Sessions of the same network slice that RR are not available. The SMF(s) takes actions to suspend the UP resources of the PDU Session associated with the network slice.
   B. Send NAS MM message to the UE to suspend the UP connections for the network slice.
If the RR become available again (either indicated by the RAN or SMF), the AMF sends indication to the other SMFs serving the PDU Sessions of the same network slice, to inform that the RR are available again.
If the UE is about to transfers to Idle state (but N1 signaling connection has not released yet), the AMF sends indication to all SMFs serving the PDU Sessions of the same network slice, to inform that 1) the UE transferred to Idle state and 2) the RR state is unknown.
   Based on this indication, the SMF may decide to disable the suspended UP resources, i.e., to allow establishment of UP resources.

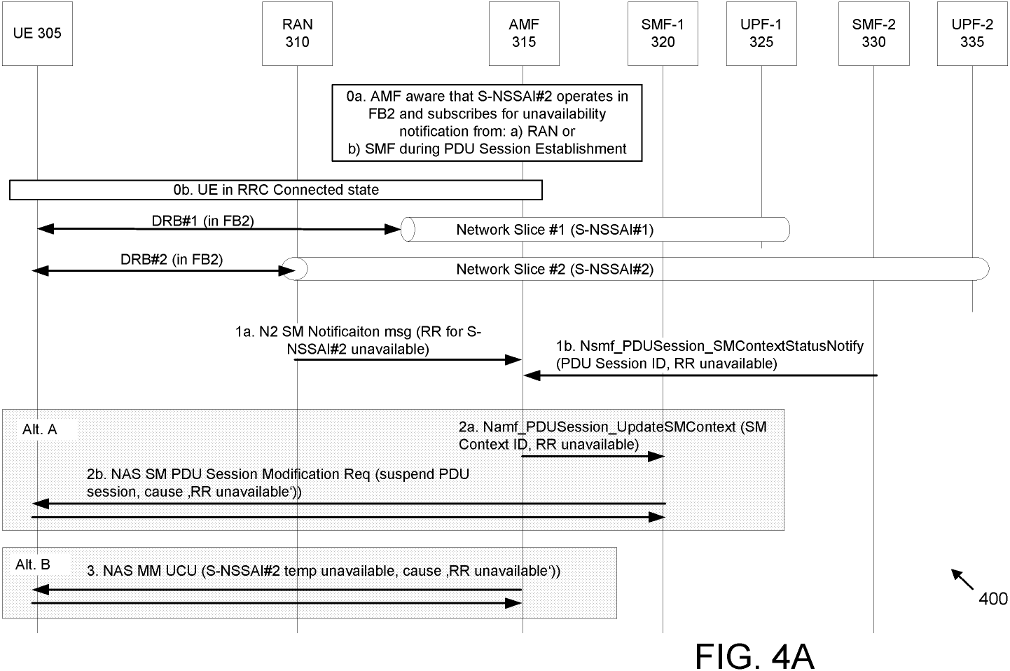

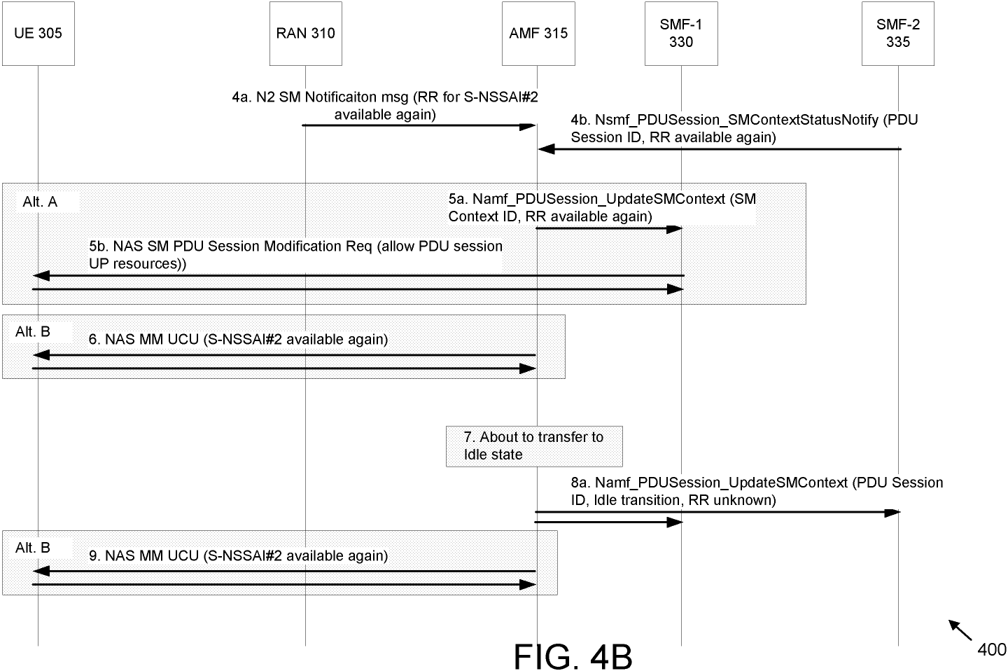

FIGS. 4A-4B depict a procedure 400 for suspending the UP resource use for a network slice (multiple PDU Sessions) due to radio conditions, according to embodiments of the second solution. The procedure 400 involves the UE 305, the RAN 310, the AMF 315, the SMF-1 320, the UPF-1 325, the SMF-2 330, and the UPF-2 335. The procedure 400 shows the signaling flow how to suspend and re-enable the UP resource for a network slice (multiple PDU Sessions) due to radio conditions, which is beneficial in case of multiple PDU Sessions established to the same network slice and especially if the PDU Sessions are served by different SMFs.

Beginning on FIG. 4A, at Step 0a the AMF 315 is aware about that the network slices allowed for a UE 305 are operating in different frequency bands. The AMF 315 subscribes with the RAN 310 or SMF 320, 330 to be informed if the radio resources (“RR”) for a particular slice (e.g., S-NSSAI#2) are not available.

At Step 0b, the UE 305 is in Connected state and uses one PDU Session for network slice #2 (S-NSSAI#2). This PDU Session is served by SMF-2 330 and in the user plane by UPF-2 335. It is assumed that there is another PDU Session to Network Slice #1 (S-NSSAI#1) which is served in the control plane by SMF-1 320 and in the user plane by UPF-1 325 and the DRB#1 is used for the connection of this PDU Session.

At Step 1a, the RAN 310 may determine that the radio resources (“RR”) for the network slice #2 (S-NSSAI#2) are not available. For example, steps 1, 2 and 3 from FIG. 3A may occur. The RAN 310 may indicate the unavailable RR for the network slice to the AMF 315 via a N2 Notification message. For example, the RAN 310 may send N2 SM Notification message (RR for S-NSSAI#2 unavailable).

At Step 1b (an alternative to Step 1a), the SMF-2 330 may determine as per solution in FIGS. 3A-3C that the radio resources for S-NSSAI#2 are unavailable. The SMF-2 330 notifies the AMF 315 about the radio resources for S-NSSAI#2 are unavailable. The SMF-2 330 may invoke the service operation Nsmf_PDUSession_SMContextStatusNotify (PDU Session ID, radio resources unavailable).

At Step 2a (Alternative A), the AMF 315 triggers PDU session context modification to the SMFs serving the UE’s PDU sessions when the AMF 315 determines that the radio resources for S-NSSAI#2 are unavailable. The AMF 315 may invoke the service operation Nsmf_PDUSession_UpdateSMContext (SM Context ID, radio resources unavailable) or Namf_PDUSession_UpdateSMContext (SM Context ID, radio resources unavailable).

At Step 2b, the SMF-2 330 may decide to suspend the UP resources for the PDU Session. The SMF may trigger NAS SM procedure to inform the UE correspondingly, e.g., as shown in steps 4 and 5 in FIGS. 3A-3B.

At Step 3 (Alternative B), the AMF 315 initiates NAS MM procedure (e.g., UE Configuration Updated procedure) towards the UE 305 to configure the UE 305 to not use the PDU Session(s) currently established to S-NSSAI#2. The AMF 315 may inform the UE 305 about the reason of unavailable S-NSSAI#2, e.g., due to unavailable radio resources. After receiving this indication, the UE 305 internally informs all corresponding NAS SM contexts of all PDU Sessions associated with S-NSSAI#2.

The NAS SM contexts enable the suspended state for the UP resources of the PDU Sessions. With other words, the NAS 5G-MM layer 255 in the UE 305 informs the NAS 5G-SM layer 260 about the need to suspend the UP resources. The release of the UP resources is performed by the RAN 310, e.g., via release of the associated DRBs. Please note that this step may be performed in addition to Alternative A. Further, the UE 205 will not establish new PDU Session(s) associated with S-NSSAI#2 or initiate PDU Session modifications to existing PDU Sessions associated with S-NSSAI#2.

Continuing on FIG. 4B, at Step 4a, the RAN 310 may determine that the RR for the network slice #2 (S-NSSAI#2) are available again (e.g., while the UE 205 is in Connected state). For example, steps 7 and 8 from FIGS. 2 may occur. The RAN 310 notifies the AMF 315 about the radio resources for S-NSSAI#2 are available again.

At Step 4b, the SMF-2 330 may determine that the RR for the network slice #2 (S-NSSAI#2) are available again. For example, step 9 from FIGS. 2 may occur. The SMF-2 330 notifies the AMF 315 about the radio resources for S-NSSAI#2 are available again.

At Step 5 (Alternative A), the AMF 315 triggers PDU session context modification to the SMF(s) serving the UE’s PDU sessions when the AMF 315 determines that the RR for S-NSSAI#2 is available again. The SMF(s) update the PDU Session context.

At Step 6 (Alternative B), in correspondence to step 3, the AMF 315 initiates NAS MM procedure (e.g., UE Configuration Updated procedure) towards the UE 305 to configure the UE 305 that the RR for S-NSSAI#2 is available again.

At Step 7, at any time, if the AMF 315 determines that the UE 305 is about to transfer to Idle state (e.g., by UE context release request from the RAN node) and based on the fact that the AMF 315 has performed steps 2 or 3 above, the AMF 315 determines to send notifications either to the corresponding SMFs (e.g., step 8a) or to the UE (e.g., step 8b). The notifications are meant to inform the receiving entities (e.g., SMF or UE) that the availability of the RR for S-NSSAI#2 is undetermined or unknown.

At Step 8 (Alternative A), the AMF 315 sends notification to the SMF(s) that the UE 305 transitions to Idle state and the RR are unknown. For example, the AMF 315 may invoke the service operation Namf_PDUSession_UpdateSMContext (PDU Session ID, Idle transition, RR unknown). The SMF-2 330 may decide to perform step 10 from FIGS. 2.

At Step 9 (Alternative B), in correspondence to step 3, the AMF 315 initiates NAS MM procedure (e.g., UE Configuration Updated procedure) towards the UE to configure the UE 305 that the RR availability for S-NSSAI#2 is unknown. The UE 305 determines to enable the use of the UP resources for the S-NSSAI#2, e.g., based on internal UE monitoring of the FB2 resources.

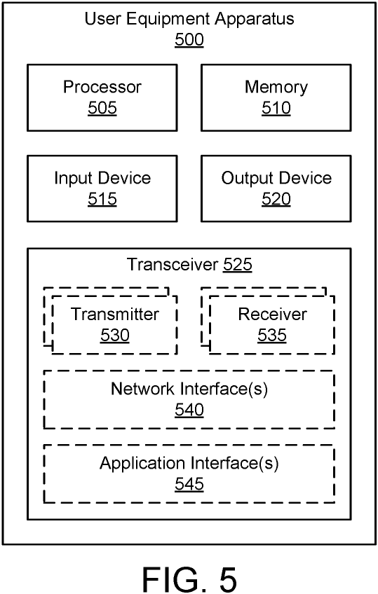

FIG. 5 depicts a user equipment apparatus 500 that may be used for improved suspension of a data connection, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 controls the transceiver 525 to receive from a CNF (e.g., SMF, AMF) an indication to suspend UP resources of a first data connection that uses a first network slice and receives a configuration message from a RNF (e.g., gNB, eNB), said message containing an indication to release a data radio bearer of the first data connection and an indication to monitor and report radio resources associated with the first network slice. The processor 505 suspends UP resources of a first data connection and monitors/reports the radio resources associated with the first network slice according to the received configuration.

In some embodiments, the transceiver 525 further receives an activation indication to activate UP resources of the first data connection. In such embodiments, the processor 505 stops blocking the uplink data for the first data connection and the processor 505 requests the activation of the user plane connection (i.e., if there are uplink packets for transmission) in response to the activation indication. In one embodiment, requesting the activation of the UP connection includes sending to an AMF a NAS request message (e.g., Service Request) which includes the PDU Session ID of the sessions to be activated.

In some embodiments, the processor 505 further blocks the uplink data for the suspended user plane connection until further notification (e.g., from the network or from lower layers, such as the AS layer) arrives in response to receiving the indication to suspend UP resources of the first data connection. In some embodiments, receiving the indication from the CNF includes receiving a session modification command message from the CNF to suspend the first data connection and to block UP resource activation until further notification from the CNF.

In some embodiments, the processor 505 monitors the radio resources associated with the first network slice using a different measurement method than used to measure neighboring cells. In certain embodiments, the receiving the configuration message from the RNF further includes receiving a distinct measurement object (i.e., different from the normal performance requirements) to measure and report the radio resources associated with the first network slice.

In some embodiments, the processor 505 sends a first reporting message to the RNF indicating inability to use a frequency resource (e.g., a frequency band/carrier of the network slice). In such embodiments, receiving the indication to suspend UP resources and receiving the configuration message occur after sending the first reporting message. In certain embodiments, the processor 505 sends the first reporting message in response to determining a reduced radio capability (“RC”) corresponding to the first data connection. In certain embodiments, the processor 505 sends the first reporting message in response to determining that the apparatus is located outside a radio coverage area of the first network slice. In certain embodiments, the transceiver 525 further sends a second reporting message after receiving the configuration message, said second reporting message indicating that the radio resources associated with the first network slice are available.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to improved suspension of a data connection. For example, the memory 510 may store various parameters, panel/beam configurations, resource assignments, policies, and the like as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

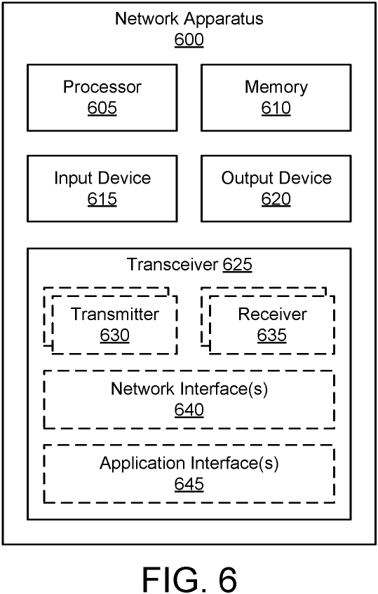

FIG. 6 depicts a network apparatus 600 that may be used for improved suspension of a data connection, according to embodiments of the disclosure. In one embodiment, network apparatus 600 may be one implementation of a RAN node, such as the base unit 121 and/or the RAN node 210, as described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 65. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In various embodiments, the processor 605 determines an unavailability of radio resources corresponding to a first data connection that uses a first network slice. The network interface 640 sends a notification message to a CNF (e.g., SMF), said message comprising an indication of the unavailability of the radio resources corresponding to the first data connection. The network interface 640 receives a first request message from the CNF, said message comprising an indication to release UP resources corresponding to the first data connection and further comprising an indication to monitor and report an availability of the unavailable radio resources. The transceiver 625 (e.g., radio interface) sends a configuration message to a UE to release at least one data radio bearer associated with the first data connection and to monitor and report radio resources and/or radio capabilities associated with the first network slice.

In some embodiments, the transceiver 625 receives a first reporting message from the UE indicating inability to use a frequency resource (e.g., a frequency band/carrier of the network slice), where the processor 605 determines the unavailability of radio resources from the first reporting message. In such embodiments, sending the notification message occurs in response to receiving the first reporting message. In certain embodiments, the transceiver 625 further receives a second reporting message from the UE after sending the configuration message, said second reporting message indicating that the radio resources associated with the first network slice are available.

In some embodiments, the processor 605 determines that the radio resources corresponding to the first data connection are available again. In such embodiments, the network interface 640 sends a second notification message to the CNF, said message indicating that the unavailable radio resources are available again. In certain embodiments, the network interface 640 receives a second request message from the CNF, said message comprising an indication to activate UP resources corresponding to the first data connection. In such embodiments, the processor 605 establishes a new data radio bearer with the UE in response to the second request message.

In some embodiments, the first network slice is associated with a first set of frequency resources. In such embodiments, the configuration message is sent to the UE using a second set of frequency resources. In some embodiments, the first request message to the RNF comprises a NAS request message (e.g., PDU Session Modification request) to suspend the UP resources of the data connection and an indication to maintain a CP connection of the first data connection (i.e., to keep an N2 SM signaling context between the RAN and the CNF/SMF).

In various embodiments, the processor 605 controls network apparatus 600 to perform the SMF behaviors described herein. In some embodiments, the network interface 640 receives a notification message from a RNF (e.g., gNB, eNB), said message comprising an indication of an unavailability of radio resources corresponding to a first data connection that uses a first network slice. The processor 605 determines that UP resources of the first data connection are to be suspended and controls the network interface 640 to send a first request message to the RNF, said message comprising an indication to release UP resources corresponding to the first data connection and further comprising an indication to monitor and report an availability of the unavailable radio resources.

In some embodiments, the first request message to the RNF comprises a NAS request message (e.g., a PDU Session Modification request) to suspend the UP resources of the data connection and an indication to maintain a CP connection of the first data connection (i.e., keep an N2 SM signaling context between the RAN and SMF), and wherein the processor 605 instructs a UPF to suspend the transmission of downlink packets.

In some embodiments, the network interface 640 receives a second notification message from the RNF, said message indicating that the unavailable radio resources are available again. In such embodiments, the processor 605 further determines to enable the UP resources of the data connection network slice. In certain embodiments, the network interface 640 sends a second request message to the RNF, said message comprising an indication to activate UP resources corresponding to the first data connection. In further embodiments, the processor 605 instructs a user plane function to buffer or discard downlink packets for the first data connection while the radio resources remain unavailable, where the processor 605 sends buffered data packets to the UE in response to the UP resources corresponding to the first data connection being activated.

In various embodiments, the processor 605 controls network apparatus 600 to perform the AMF behaviors described herein. In some embodiments, the processor 605 subscribes for unavailability notifications from a network function (e.g., from SMF or RAN). The processor 605 controls the network interface 640 to receive a notification message from the network function, said message containing an indication of an unavailability of radio resources corresponding to a first data connection that uses a first network slice. The processor 605 triggers the suspending of UP resources for the network slice in response to the notification message.

In some embodiments, triggering the suspending of UP resources for the network slice includes sending a configuration update message to a UE, said message containing an indication to suspend UP resources corresponding to the network slice. In some embodiments, triggering the suspending of UP resources for the network slice includes sending a context modification message to a SMF, said message containing an indication of the unavailability of the radio resources corresponding to a first data connection that uses a first network slice.

In some embodiments, the network interface 640 receives a second notification message from the network function (e.g., SMF or RAN), said message indicating that the unavailable radio resources are available again. In such embodiments, the processor 605 further determines to trigger the activation of UP resources for the network slice in response to the second notification message.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to improved suspension of a data connection. For example, the memory 610 may store parameters, configurations, resource assignments, policies, and the like, as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

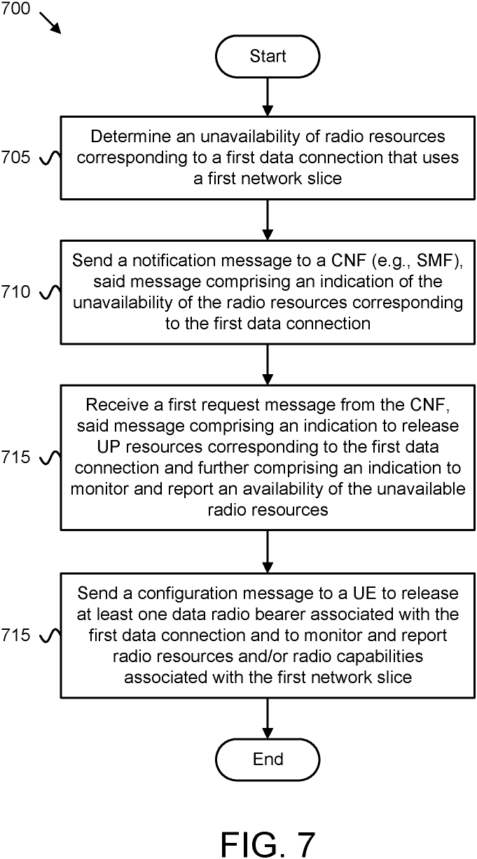

FIG. 7 depicts one embodiment of a method 700 for suspending a data connection (e.g., PDU Session) for a network slice, according to embodiments of the disclosure. In various embodiments, the method 700 is performed by a radio network function in a mobile communication network, such as the base unit 121, the RAN node 210, and/or the network apparatus 600, described above. In some embodiments, the method 700 is performed by a processor, such as a microcontroller, a microprocessor, a CPU, a GPU, an auxiliary processing unit, a FPGA, or the like.

The method 700 begins and determines 705 an unavailability of radio resources corresponding to a first data connection that uses a first network slice. The method 700 includes sending 710 a notification message to a CNF (e.g., SMF), said message comprising an indication of the unavailability of the radio resources corresponding to the first data connection. The method 700 includes receiving 715 a first request message from the CNF, said message comprising an indication to release UP resources corresponding to the first data connection and further comprising an indication to monitor and report an availability of the unavailable radio resources. The method 700 includes sending 720 a configuration message to a UE to release at least one data radio bearer associated with the first data connection and to monitor and report radio resources and/or radio capabilities associated with the first network slice. The method 700 ends.

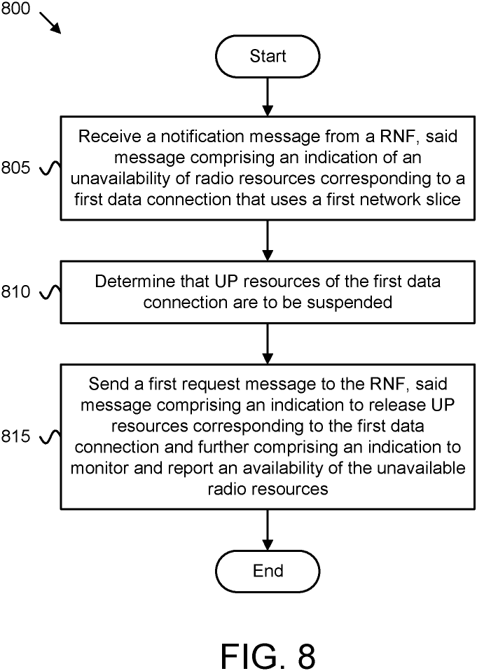

FIG. 8 depicts one embodiment of a method 800 for suspending a data connection (e.g., PDU Session) for a network slice, according to embodiments of the disclosure. In various embodiments, the method 800 is performed by a core network function in a mobile communication network, such as the SMF 145, the SMF 215, the SMF-1 320, the SMF-2 330, and/or the network apparatus 600, described above. In some embodiments, the method 800 is performed by a processor, such as a microcontroller, a microprocessor, a CPU, a GPU, an auxiliary processing unit, a FPGA, or the like.

The method 800 begins and receives 805 a notification message from a RNF (e.g., gNB, eNB), said message comprising an indication of an unavailability of radio resources corresponding to a first data connection that uses a first network slice. The method 800 includes determining 810 that UP resources of the first data connection are to be suspended. The method 800 includes sending 815 a first request message to the RNF, said message comprising an indication to release UP resources corresponding to the first data connection and further comprising an indication to monitor and report an availability of the unavailable radio resources. The method 800 ends.

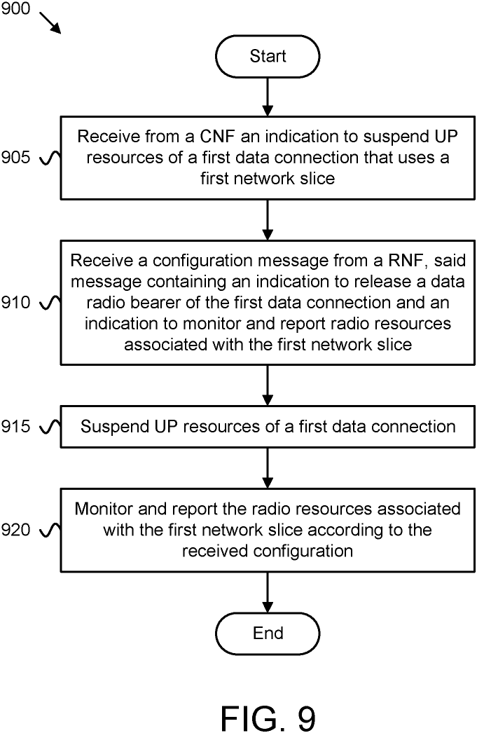

FIG. 9 depicts one embodiment of a method 900 for suspending a data connection (e.g., PDU Session) for a network slice, according to embodiments of the disclosure. In various embodiments, the method 900 is performed by a user equipment device in a mobile communication network, such as the remote unit 105, the UE 205, and/or the user equipment apparatus 500, described above. In some embodiments, the method 900 is performed by a processor, such as a microcontroller, a microprocessor, a CPU, a GPU, an auxiliary processing unit, a FPGA, or the like.

The method 900 begins and receives 905 from a core network function (“CNF”) (e.g., SMF, AMF) an indication to suspend UP resources of a first data connection that uses a first network slice. The method 900 includes receiving 910 a configuration message from a radio network function (“RNF”) (e.g., gNB, eNB), said message containing an indication to release a data radio bearer of the first data connection and an indication to monitor and report radio resources associated with the first network slice. The method 900 includes suspending 915 UP resources of a first data connection. The method 900 includes monitoring and reporting 920 the radio resources associated with the first network slice according to the received configuration. The method 900 ends.

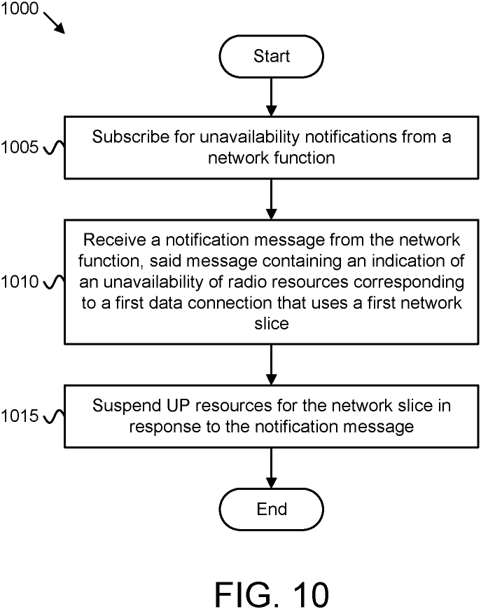

FIG. 10 depicts one embodiment of a method 1000 for suspending a data connection (e.g., PDU Session) for a network slice, according to embodiments of the disclosure. In various embodiments, the method 1000 is performed by a core network function in a mobile communication network, such as the AMF 143, the AMF 213, the AMF 315, and/or the network apparatus 600, described above. In some embodiments, the method 1000 is performed by a processor, such as a microcontroller, a microprocessor, a CPU, a GPU, an auxiliary processing unit, a FPGA, or the like.

The method 1000 begins and subscribes 1005 for unavailability notifications from a network function (e.g., from SMF or RAN). The method 1000 includes receiving 1010 a notification message from the network function, said message containing an indication of an unavailability of radio resources corresponding to a first data connection that uses a first network slice. The method 1000 includes suspending 1015 UP resources for the network slice in response to the notification message. The method 1000 ends.

Disclosed herein is a first apparatus for suspending a data connection (e.g., PDU Session) for a network slice, according to embodiments of the disclosure. The first apparatus may be implemented by a RAN device in a mobile communication network, such as the base unit 121, the RAN node 210, and/or the network apparatus 600, described above. The first apparatus includes a radio transceiver, a network interface and a processor that determines an unavailability of radio resources corresponding to a first data connection that uses a first network slice. The network interface sends a notification message to a CNF (e.g., SMF), said message comprising an indication of the unavailability of the radio resources corresponding to the first data connection. The network interface receives a first request message from the CNF, said message comprising an indication to release UP resources corresponding to the first data connection and further comprising an indication to monitor and report an availability of the unavailable radio resources. The transceiver (e.g., radio interface) sends a configuration message to a UE to release at least one data radio bearer associated with the first data connection and to monitor and report radio resources and/or radio capabilities associated with the first network slice.

In some embodiments, the transceiver receives a first reporting message from the UE indicating inability to use a frequency resource (e.g., a frequency band/carrier of the network slice), where the processor determines the unavailability of radio resources from the first reporting message. In such embodiments, sending the notification message occurs in response to receiving the first reporting message. In certain embodiments, the transceiver further receives a second reporting message from the UE after sending the configuration message, said second reporting message indicating that the radio resources associated with the first network slice are available.

In some embodiments, the processor determines that the radio resources corresponding to the first data connection are available again. In such embodiments, the network interface sends a second notification message to the CNF, said message indicating that the unavailable radio resources are available again. In certain embodiments, the network interface receives a second request message from the CNF, said message comprising an indication to activate UP resources corresponding to the first data connection. In such embodiments, the processor establishes a new data radio bearer with the UE in response to the second request message.

In some embodiments, the first network slice is associated with a first set of frequency resources. In such embodiments, the configuration message is sent to the UE using a second set of frequency resources. In some embodiments, the first request message to the RNF comprises a NAS request message (e.g., PDU Session Modification request) to suspend the UP resources of the data connection and an indication to maintain a CP connection of the first data connection (i.e., to keep an N2 SM signaling context between the RAN and the CNF/SMF).

Disclosed herein is a first method for suspending a data connection (e.g., PDU Session) for a network slice, according to embodiments of the disclosure. The first method may be performed by a RAN device in a mobile communication network, such as the base unit 121, the RAN node 210, and/or the network apparatus 600, described above. The first method includes determining an unavailability of radio resources corresponding to a first data connection that uses a first network slice and sending a notification message to a CNF (e.g., SMF), said message comprising an indication of the unavailability of the radio resources corresponding to the first data connection. The first method includes receiving a first request message from the CNF, said message comprising an indication to release UP resources corresponding to the first data connection and further comprising an indication to monitor and report an availability of the unavailable radio resources. The first method includes sending a configuration message to a UE to release at least one data radio bearer associated with the first data connection and to monitor and report radio resources and/or radio capabilities associated with the first network slice.

In some embodiments, the first method includes receiving a first reporting message from the UE indicating inability to use a frequency resource (e.g., a frequency band/carrier of the network slice), where the unavailability of radio resources is determined from the first reporting message. In such embodiments, sending the notification message occurs in response to receiving the first reporting message. In certain embodiments, the first method further includes receiving a second reporting message from the UE after sending the configuration message, said second reporting message indicating that the radio resources associated with the first network slice are available.

In some embodiments, the first method includes determining that the radio resources corresponding to the first data connection are available again and sending a second notification message to the CNF, said message indicating that the unavailable radio resources are available again. In certain embodiments, the first method includes receiving a second request message from the CNF, said message comprising an indication to activate UP resources corresponding to the first data connection. In such embodiments, the first method further includes establishing a new data radio bearer with the UE in response to the second request message.

In some embodiments, the first network slice is associated with a first set of frequency resources. In such embodiments, the configuration message is sent to the UE using a second set of frequency resources. In some embodiments, the first request message to the RNF comprises a NAS request message (e.g., PDU Session Modification request) to suspend the UP resources of the data connection and an indication to maintain a CP connection of the first data connection (i.e., to keep an N2 SM signaling context between the RAN and the CNF/SMF).

Disclosed herein is a second apparatus for suspending a data connection (e.g., PDU Session) for a network slice, according to embodiments of the disclosure. The second apparatus may be implemented by a session management node in a mobile communication network, such as the SMF 145, the SMF 215, the SMF-1 320, the SMF-2 330, and/or the network apparatus 600, described above. The second apparatus includes a processor and a network interface that receives a notification message from a RNF (e.g., gNB, eNB), said message comprising an indication of an unavailability of radio resources corresponding to a first data connection that uses a first network slice. The processor determines that UP resources of the first data connection are to be suspended; and controls the transceiver to send a first request message to the RNF, said message comprising an indication to release UP resources corresponding to the first data connection and further comprising an indication to monitor and report an availability of the unavailable radio resources.

In some embodiments, the first request message to the RNF comprises a NAS request message (e.g., a PDU Session Modification request) to suspend the UP resources of the data connection and an indication to maintain a CP connection of the first data connection (i.e., keep an N2 SM signaling context between the RAN and SMF), and wherein the processor instructs a UPF to suspend the transmission of downlink packets.

In some embodiments, the network interface receives a second notification message from the RNF, said message indicating that the unavailable radio resources are available again. In such embodiments, the processor further determines to enable the UP resources of the data connection network slice. In certain embodiments, the network interface sends a second request message to the RNF, said message comprising an indication to activate UP resources corresponding to the first data connection. In further embodiments, the processor instructs a user plane function to buffer or discard downlink packets for the first data connection while the radio resources remain unavailable, where the processor sends buffered data packets to the UE in response to the UP resources corresponding to the first data connection being activated.

Disclosed herein is a second method for suspending a data connection (e.g., PDU Session) for a network slice, according to embodiments of the disclosure. The second method may be performed by a session management node in a mobile communication network, such as the SMF 145, the SMF 215, the SMF-1 320, the SMF-2 330, and/or the network apparatus 600, described above. The second method includes receiving a notification message from a RNF (e.g., gNB, eNB), said message comprising an indication of an unavailability of radio resources corresponding to a first data connection that uses a first network slice. The second method includes determining that UP resources of the first data connection are to be suspended and sending a first request message to the RNF, said message comprising an indication to release UP resources corresponding to the first data connection and further comprising an indication to monitor and report an availability of the unavailable radio resources.

In some embodiments, the first request message to the RNF comprises a NAS request message (e.g., a PDU Session Modification request) to suspend the UP resources of the data connection and an indication to maintain a CP connection of the first data connection (i.e., keep an N2 SM signaling context between the RAN and SMF). In such embodiments, the second method includes instructing a UPF to suspend the transmission of downlink packets.

In some embodiments, the second method includes receiving a second notification message from the RNF, said message indicating that the unavailable radio resources are available again. In such embodiments, the second method includes determining to enable the UP resources of the data connection network slice. In certain embodiments, the second method includes sending a second request message to the RNF, said message comprising an indication to activate UP resources corresponding to the first data connection. In further embodiments, the second method includes instructing a user plane function to buffer or discard downlink packets for the first data connection while the radio resources remain unavailable and sending buffered data packets to the UE in response to the UP resources corresponding to the first data connection being activated.

Disclosed herein is a third apparatus for suspending a data connection (e.g., PDU Session) for a network slice, according to embodiments of the disclosure. The third apparatus may be implemented by a user equipment device in a mobile communication network, such as the remote unit 105, the UE 205, and/or the user equipment apparatus 500, described above. The third apparatus includes a processor and a transceiver that receives from a CNF (e.g., SMF, AMF) an indication to suspend UP resources of a first data connection that uses a first network slice and receives a configuration message from a RNF (e.g., gNB, eNB), said message containing an indication to release a data radio bearer of the first data connection and an indication to monitor and report radio resources associated with the first network slice. The processor suspends UP resources of a first data connection and monitors/reports the radio resources associated with the first network slice according to the received configuration.

In some embodiments, the processor further blocks the uplink data for the suspended user plane connection until further notification (e.g., from the network or from lower layers, such as the AS layer) arrives in response to receiving the indication to suspend UP resources of the first data connection.

In some embodiments, the transceiver further receives an activation indication to activate UP resources of the first data connection. In such embodiments, the processor stops blocking the uplink data for the first data connection and the processor requests the activation of the user plane connection (i.e., if there are uplink packets for transmission) in response to the activation indication. In one embodiment, requesting the activation of the UP connection includes sending to an AMF a NAS request message (e.g., Service Request) which includes the PDU Session ID of the sessions to be activated.

In some embodiments, receiving the indication from the CNF includes receiving a session modification command message from the CNF to suspend the first data connection and to block UP resource activation until further notification from the CNF. In some embodiments, the processor monitors the radio resources associated with the first network slice using a different measurement method than used to measure neighboring cells. In certain embodiments, the receiving the configuration message from the RNF further includes receiving a distinct measurement object (i.e., different from the normal performance requirements) to measure and report the radio resources associated with the first network slice.

In some embodiments, the processor sends a first reporting message to the RNF indicating inability to use a frequency resource (e.g., a frequency band/carrier of the network slice). In such embodiments, receiving the indication to suspend UP resources and receiving the configuration message occur after sending the first reporting message. In certain embodiments, the transceiver sends the first reporting message in response to the processor determining a reduced radio capability (“RC”) corresponding to the first data connection. In certain embodiments, the transceiver sends the first reporting message in response to the processor determining that the apparatus is located outside a radio coverage area of the first network slice. In certain embodiments, the transceiver further sends a second reporting message after receiving the configuration message, said second reporting message indicating that the radio resources associated with the first network slice are available.

Disclosed herein is a third method for suspending a data connection (e.g., PDU Session) for a network slice, according to embodiments of the disclosure. The third method may be performed by a user equipment device in a mobile communication network, such as the remote unit 105, the UE 205, and/or the user equipment apparatus 500, described above. The third method includes receiving from a CNF (e.g., SMF, AMF) an indication to suspend UP resources of a first data connection that uses a first network slice and receiving a configuration message from a RNF (e.g., gNB, eNB), said message containing an indication to release a data radio bearer of the first data connection and an indication to monitor and report radio resources associated with the first network slice. The third method includes suspending UP resources of a first data connection and monitoring/reporting the radio resources associated with the first network slice according to the received configuration.

In some embodiments, the third method further includes: receiving an activation indication to activate UP resources of the first data connection, stopping the blocking the uplink data for the first data connection, and requesting the activation of the user plane connection (i.e., if there are uplink packets for transmission) in response to the activation indication. In one embodiment, requesting the activation of the UP connection includes sending to an AMF a NAS request message (e.g., Service Request) which includes the PDU Session ID of the sessions to be activated.

In some embodiments, the third method further includes blocking the uplink data for the suspended user plane connection until further notification (e.g., from the network or from lower layers, such as the AS layer) arrives in response to receiving the indication to suspend UP resources of the first data connection. In some embodiments, receiving the indication from the CNF includes receiving a session modification command message from the CNF to suspend the first data connection and to block UP resource activation until further notification from the CNF.

In some embodiments, the third method further includes monitoring the radio resources associated with the first network slice using a different measurement method than used to measure neighboring cells. In certain embodiments, receiving the configuration message from the RNF further includes receiving a distinct measurement object (i.e., different from the normal performance requirements) to measure and report the radio resources associated with the first network slice.

In some embodiments, the third method further includes sending a first reporting message to the RNF indicating inability to use a frequency resource (e.g., a frequency band/carrier of the network slice). In such embodiments, receiving the indication to suspend UP resources and receiving the configuration message occur after sending the first reporting message. In certain embodiments, the third method further includes sending the first reporting message in response to determining a reduced radio capability (“RC”) corresponding to the first data connection. In certain embodiments, the third method further includes sending the first reporting message in response to determining that the UE is located outside a radio coverage area of the first network slice. In certain embodiments, the third method further includes sending a second reporting message after receiving the configuration message, said second reporting message indicating that the radio resources associated with the first network slice are available.

Disclosed herein is a fourth apparatus for suspending a data connection (e.g., PDU Session) for a network slice, according to embodiments of the disclosure. The fourth apparatus may be implemented by an access and mobility management node in a mobile communication network, such as the AMF 143, the AMF 213, the AMF 315, and/or the network apparatus 600, described above. The fourth apparatus includes a network interface and a processor that subscribes for unavailability notifications from a network function (e.g., from SMF or RAN). The processor controls the network interface to receive a notification message from the network function, said message containing an indication of an unavailability of radio resources corresponding to a first data connection that uses a first network slice. The processor triggers the suspending of UP resources for the network slice in response to the notification message.

In some embodiments, triggering the suspending of UP resources for the network slice includes sending a configuration update message to a UE, said message containing an indication to suspend UP resources corresponding to the network slice. In some embodiments, triggering the suspending of UP resources for the network slice includes sending a context modification message to a SMF, said message containing an indication of the unavailability of the radio resources corresponding to a first data connection that uses a first network slice.

In some embodiments, the network interface receives a second notification message from the network function (e.g., SMF or RAN), said message indicating that the unavailable radio resources are available again. In such embodiments, the processor further determines to trigger the activation of UP resources for the network slice in response to the second notification message.

Disclosed herein is a fourth method for suspending a data connection (e.g., PDU Session) for a network slice, according to embodiments of the disclosure. The fourth method may be performed by an access and mobility management node in a mobile communication network, such as the AMF 143, the AMF 213, the AMF 315, and/or the network apparatus 600, described above. The fourth method includes subscribing for unavailability notifications from a network function (e.g., from SMF or RAN) and receiving a notification message from the network function, said message containing an indication of an unavailability of radio resources corresponding to a first data connection that uses a first network slice. The fourth method includes suspending of UP resources for the network slice in response to the notification message.

In some embodiments, triggering the suspending of UP resources for the network slice includes sending a configuration update message to a UE, said message containing an indication to suspend UP resources corresponding to the network slice. In some embodiments, triggering the suspending of UP resources for the network slice includes sending a context modification message to a SMF, said message containing an indication of the unavailability of the radio resources corresponding to a first data connection that uses a first network slice.

In some embodiments, the fourth method includes receiving a second notification message from the network function (e.g., SMF or RAN), said message indicating that the unavailable radio resources are available again. In such embodiments, the fourth method further includes triggering the activation of UP resources for the network slice in response to the second notification message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-15. (canceled)

16. A User Equipment (“UE”) apparatus comprising:
a memory; and
a processor coupled to the memory, the processor configured to cause the apparatus to:
receive a configuration message from a radio network function (“RNF”), the configuration message comprising an indication to release a data radio bearer of the first data connection and an indication to monitor and report radio resources associated with a first network slice;
suspend user plane (“UP”) resources of a first data connection; and
monitor and report the radio resources associated with the first network slice according to the received configuration.

17. The apparatus of claim 16, wherein the processor is configured to cause the apparatus to block the uplink data for the suspended user plane connection until further notification arrives in response to receiving the indication to suspend UP resources of the first data connection.

18. The apparatus of claim 16, wherein the processor is configured to cause the apparatus to:
receive an activation indication to activate UP resources of the first data connection;
stop blocking the uplink data for the first data connection; and
request the activation of the user plane connection in response to the activation indication.

19. The apparatus of claim 16, wherein the processor is configured to cause the apparatus to receive from a core network function (“CNF”) an indication to suspend UP resources of a respective data connection that uses a first network slice.

20. The apparatus of claim 19, wherein to receive the indication from the CNF, the processor is configured to cause the apparatus to receive, from the CNF, a session modification command message comprising an indication to suspend the first data connection and to block UP resource activation until further notification from the CNF.

21. The apparatus of claim 16, wherein the processor is configured to cause the apparatus to monitor the radio resources associated with the first network slice using a different measurement method than used to measure neighboring cells, wherein to receive the configuration message from the RNF, the processor is configured to cause the apparatus to receive a distinct measurement object to measure and report the radio resources associated with the first network slice.

22. The apparatus of claim 16, wherein the processor is configured to cause the apparatus to send a first reporting message to the RNF indicating inability to use a frequency resource, wherein receiving the indication to suspend UP resources and receiving the configuration message occur after sending the first reporting message.

23. The apparatus of claim 22, wherein the processor is configured to cause the apparatus to send the first reporting message in response to determining a reduced radio capability corresponding to the first data connection.

24. The apparatus of claim 22, wherein the processor is configured to cause the apparatus to send the first reporting message in response to determining that the apparatus is located outside a radio coverage area of the first network slice.

25. The apparatus of claim 22, wherein the transceiver further sends a second reporting message after receiving the configuration message, said second reporting message indicating that the radio resources associated with the first network slice are available.

26. A Radio Access Network (“RAN”) apparatus comprising:
a memory; and
a processor coupled to the memory, the processor configured to cause the apparatus to:
determine an unavailability of radio resources corresponding to a first data connection that uses a first network slice;
send a notification message to a core network function (“CNF”), the notification message comprising an indication of the unavailability of the radio resources corresponding to the first data connection; and
receive a first request message from the CNF, the first request message comprising an indication to release user plane (“UP”) resources corresponding to the first data connection and further comprising an indication to monitor and report an availability of the unavailable radio resources; and
send a configuration message to a User Equipment device (“UE”), the configuration message comprising an indication to release at least one data radio bearer associated with the first data connection and to monitor and report radio resources associated with the first network slice.

27. The apparatus of claim 26, wherein the processor is configured to cause the apparatus to:
receive a first reporting message from the UE indicating inability to use a frequency resource, and
determine the unavailability of radio resources from the first reporting message,
wherein the processor sends the notification message in response to receiving the first reporting message.

28. The apparatus of claim 27, wherein the transceiver further receives a second reporting message from the UE after sending the configuration message, the second reporting message indicating that the radio resources associated with the first network slice are available.

29. The apparatus of claim 26, wherein the processor is configured to cause the apparatus to:
determine that the radio resources corresponding to the first data connection are available again, and
send a second notification message to the CNF, the second notification message indicating that the unavailable radio resources are available again.

30. The apparatus of claim 29, wherein the processor is configured to cause the apparatus to:
receive a second request message from the CNF, the second request message comprising an indication to activate UP resources corresponding to the first data connection, and
establish a new data radio bearer with the UE in response to the second request message.

31. A core network function apparatus comprising:
a memory; and
a processor coupled to the memory, the processor configured to cause the apparatus to:
receive a notification message from a radio network function (“RNF”), the notification message comprising an indication of an unavailability of radio resources corresponding to a first data connection that uses a first network slice; and
determine that user plane (“UP”) resources of the first data connection are to be suspended; and
send a first request message to the RNF, the first request message comprising an indication to release UP resources corresponding to the first data connection and further comprising an indication to monitor and report an availability of the unavailable radio resources.

32. The apparatus of claim 31, wherein the first request message to the RNF comprises a NAS request message comprising an indication to suspend the UP resources of the data connection and an indication to maintain a control plane (“CP”) connection of the first data connection, and wherein the processor is configured to cause the apparatus to instruct a user plane function to suspend the transmission of downlink packets.

33. The apparatus of claim 31, wherein the processor is configured to cause the apparatus to:
receive a second notification message from the RNF, the second notification message indicating that the unavailable radio resources are available again, and
determine to enable the UP resources of the data connection network slice.

34. The apparatus of claim 33, wherein the processor is configured to cause the apparatus to send a second request message to the RNF, the second request message comprising an indication to activate UP resources corresponding to the first data connection.

35. The apparatus of claim 34, wherein the processor is configured to cause the apparatus to:
instruct a user plane function to buffer downlink packets for the first data connection while the radio resources remain unavailable, and
send buffered data packets to the UE in response to the UP resources corresponding to the first data connection being activated.
